(19) United States
(12) Patent Application Publication
(10) Pub. No.: US 2026/0170732 A1
(43) Pub. Date: Jun. 18, 2026

(54) RAPID VISUAL ASSET CREATION SYSTEM

(71) Applicant: Intangible Technology Inc., San Francisco, CA (US)

(72) Inventors: Charles Migos, San Francisco, CA (US); Bharat Vasan, San Francisco, CA (US); Anjoe Jacob, San Francisco, CA (US); Joshua Chanthavisay, San Francisco, CA (US); Chethan Balakrishna, San Francisco, CA (US); Damien Mortini, San Francisco, CA (US)

(21) Appl. No.: 19/424,937

(22) Filed: Dec. 18, 2025

Related U.S. Application Data
(60) Provisional application No. 63/735,570, filed on Dec. 18, 2024.
(60) Provisional application No. 63/786,827, filed on Apr. 10, 2025.

(51) Int. Cl. G06T 11/60

(52) U.S. Cl. CPC G06T 11/60

(57) ABSTRACT

In variants, the method can include: determining a set of object instances from a scene prompt; generating a scene construct by populating a 3D scene with assets for each of the set of object instances associated with descriptions for the respective object instance; generating a set of model inputs including a geometric scene reference and a scene context from the scene construct; and generating an appearance-rendered asset based on the set of model inputs.

### CROSS-REFERENCE TO RELATED APPLICATIONS

This application claims the benefit of U.S. Provisional Application number 63/735,570 filed Dec. 18, 2024 and US Provisional Application number 63/786,827 filed Apr. 10, 2025, each of which is incorporated in its entirety by this reference.

### TECHNICAL FIELD

This invention relates generally to the generative modeling field, and more specifically to a new and useful system and method for consistently and coherently generating visual assets using a generative model in the generative modeling field.

### BRIEF DESCRIPTION OF THE DRAWINGS

FIG. 1 is a schematic representation of a variant of the method.

FIG. 2 is a schematic representation of an example of the method

FIG. 3 is a schematic representation of a variant of the system.

FIG. 4 is a schematic representation of an example of the system with a knowledge graph, relationship database, and asset database.

FIG. 5 is an illustrative example of a scene construct.

FIG. 6 is an illustrative example of generating a scene context.

FIG. 7 is a schematic representation of a variant of the scene construct generation pipeline.

FIG. 8 is a schematic representation of an example of a branch of the knowledge graph.

FIG. 9 is a schematic representation of an example of iterative scene construct generation.

FIGS. 10A and 10B are illustrative examples of an empty scene construct and a populated scene construct, respectively.

FIGS. 11A and 11B are illustrative examples of populating a scene construct using a query and populating the scene construct manually, respectively.

FIGS. 12A-12C are illustrative examples of visual assets generated using different visual styles.

FIG. 12D is an illustrative example of an updated visual asset from a different perspective of the scene, wherein the Bugatti in FIG. 12C is replaced with a Ferrari.

FIG. 12E is an illustrative example of an updated visual asset from a different perspective of the scene of FIGS. 12A-12C.

FIG. 12F is an illustrative example of an updated visual asset from a different perspective of the scene of FIGS. 12A-12C, wherein the Bugatti is replaced with a Porsche and the dynamics of the vehicle are inferred by the generative model based on a description associated with the Porsche object instance.

FIG. 13 is an illustrative example of a 3D scene aligned with the generated visual asset.

FIG. 14 is an illustrative example of selecting the visual asset segment associated with an object instance in the underlying 3D scene.

### DETAILED DESCRIPTION OF THE INVENTION

The following description of the embodiments of the invention is not intended to limit the invention to these embodiments, but rather to enable any person skilled in the art to make and use this invention.

### 1. Overview

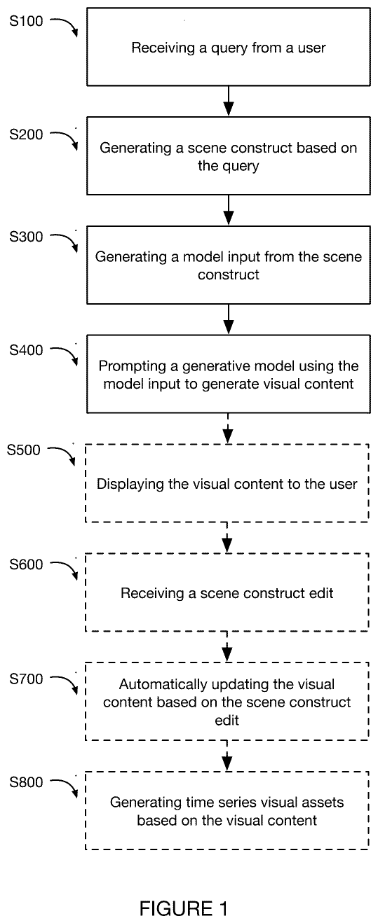

As shown in FIG. 1, variants of the method can include: receiving a query from a user S100; generating a scene construct based on the query S200; generating a model input from the scene construct S300; prompting a generative model using the model input to generate visual content S400; optionally displaying the visual content to the user S500; optionally receiving a scene construct edit S600; optionally automatically updating the visual content based on the scene construct edit S700; and optionally generating timeseries visual assets based on the visual content S800. The method functions to accurately and repeatably generate visual assets using generative models.

In an illustrative example, the method includes: receiving a scene generation query from a user; parsing the scene generation query to extract entities (e.g., object instances, concepts, etc.) from the query (e.g., using an LLM); identifying known object types from the knowledge graph based on the extracted entities; querying an LLM to describe any unknown entities (e.g., by identifying the closest known object type from the knowledge graph, by generating parameter values for the unknown entity, etc.); optionally identifying secondary objects related to the identified objects using the knowledge graph (e.g., to identify child object types, to identify additional object types based on semantic and/or hierarchical relationships) and/or a relationship database, (e.g., wherein co-occurring objects can be embedded close to each other in vector space); retrieving assets (e.g., 3D models) associated with the identified object types (e.g., known and/or newly-described object types); optionally determining parameter value sets for each entity (e.g., including entity descriptions; from the object type parameters, predicted from the scene generation query, from the relationship database, received from the user, inherited from the scene, etc.); generating a scene construct (e.g., 3D scene model, scene context, etc.) using the assets and the parameter values associated with the respective entity (e.g., by placing the asset in the scene based on the object type parameter values, probabilistically using the relationship database, based on a position specified by the user, randomly, based on a position predicted by a large model, etc.); associating each entity's parameter value sets (e.g., including the entity's descriptions) with the respective asset in the scene construct; generating a scene context from the set of parameter values (e.g., including descriptions) for both the scene as a whole and for entities within the scene (e.g., for entities within a camera's FOV, for all entities, etc.); generating a geometric scene representation (e.g., a 2D reference image sampled from a virtual camera's field of view); prompting a generative model using the scene context and the geometric scene representation to generate visual content (e.g., image, video, AV content, etc.); and displaying the visual content to the user. The method can optionally include receiving an edit to a selected entity or to the scene construct (e.g., through natural language prompting, selection from a structured set of parameter values, etc.); automatically updating the scene construct based on the edit (e.g., updating the parameter value sets for the entities and/or the scene; updating the 3D scene by adding, removing, or moving assets within the scene); generating a new scene context and/or geometric scene representation based on the updated scene construct; and automatically updating the visual content based on the updated scene context and/or geometric scene representation.

However, the system and/or method can be otherwise performed.

### 2. Technical Advantages

Variants of the technology can confer one or more advantages over conventional technologies.

First, variants of the technology can enhance the reliability and accuracy of generative models by enforcing geometric constraints by using a 3D scene construct. This can enable consistent, precise visuals across every frame. While conventional generative models may produce visual artifacts or physically impossible arrangements due to hallucinations, the technology's use of 3D scene-based constraints can ensure that generated assets maintain proper spatial relationships and physical coherence. For example, the technology can prevent objects from floating unrealistically, having the same number of toes across frames, or intersecting with other objects in physically impossible ways. This geometric coherence can result in more believable, usable, and coherent generated content for multiframe applications such as film generation, virtual environment animation, or game design. Variants of the technology can also enable greater interpretability, generalized model compatibility, and flexibility by using natural language descriptions of the scene (e.g., of the scene, of the object instances, etc.) when generating visual assets (e.g., in addition to geometric scene representations).

Second, variants of the technology can streamline the scene generation process through automated object identification and placement based on high-level prompts. The technology can leverage a sophisticated combination of relational object libraries, vector-based co-occurrence encoding, and large language models to automatically populate scenes with contextually appropriate objects. For example, when a user specifies a “forest” scene, the technology can automatically identify and place appropriate elements such as trees, undergrowth, wildlife, atmospheric effects, and lighting without requiring manual specification of each component. This automation can reduce the time and effort required for scene creation compared to traditional methods where users must manually specify and place each scene element and parameter.

Third, variants of the technology can facilitate the creation of novel object types through parameter-based modification of existing, similar objects. By utilizing large language models to specify new parameter values based on known object types from the object library, the technology can generate previously unseen objects while maintaining physical and contextual coherence. For example, the system can create a new type of fictional tree by modifying the parameters of an existing tree model, such as branch structure, leaf distribution, or trunk characteristics. This capability can expand the creative possibilities available to users while maintaining the efficiency and reliability of the generation process.

However, further advantages can be provided by the system and method disclosed herein.

### 3. System

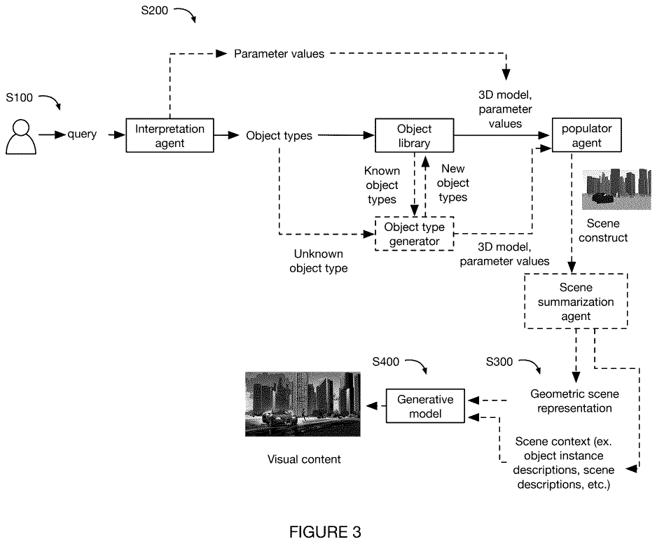

As shown in FIG. 3, variants of the system can include or be used with: an object library; a scene construct; a set of agents; a generative model; and/or other components. The system functions to provide a modular, extensible, interpretable platform for controlled media asset generation.

In examples, the platform can enable utilization of diffusion models to quickly and scalably generate visual assets, while minimizing hallucinations by providing structure and coherence. The platform can also enable 3D worlds (e.g., static worlds, dynamic worlds, etc.) to be quickly generated.

Examples of media assets that can be generated can include: individual frames (e.g., keyframes), video (e.g., animations, movies, etc.), gameplay, and/or any other media assets.

The media assets can be generated asynchronously, in real-or near-real time, and/or otherwise generated.

In a first example, the platform can automatically populate a 3D virtual environment (e.g., 3D scene) from a set of prompts (e.g., for the scene, for individual objects in the scene, etc.), wherein the 3D scene can include a set of 3D models for each of a set of object instances. Each object instance and the overall scene is associated with its own set of rendering information (e.g., parameter values, descriptors, etc.), wherein the respective set of rendering information is used to render appearance-containing media assets of the 3D virtual environment.

In a second example, the platform can render keyframes or snapshots of the 3D virtual environment asynchronously from end user display.

In a third example, the platform can generate and present new video game frames in real-or near-real time as the player interacts with the 3D virtual environment.

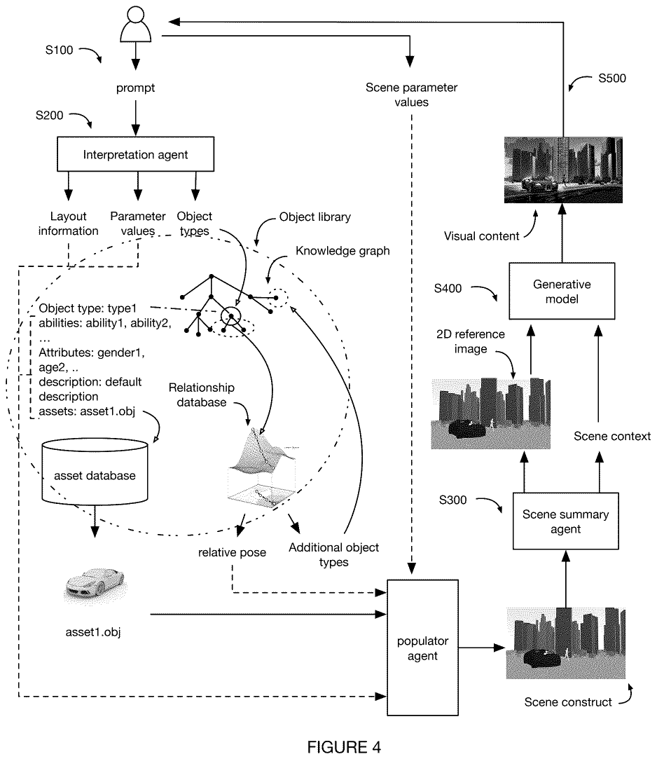

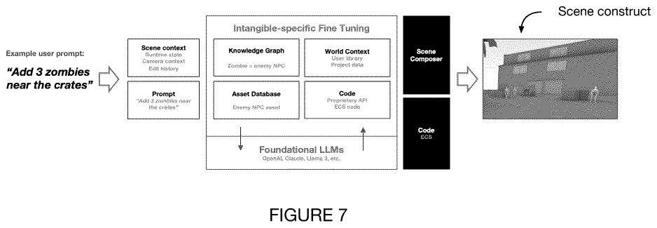

Examples of the platform are shown in FIG. 3, FIG. 4, and FIG. 7.

The object library of the platform functions to define a set of object classes that can be used within a virtual scene. In variants, the object library can function as the system of record for defining narrative structure, shots, interactivity, and/or other information for world building. The object library preferably provides an organizational schema for organizing and extending object types, but can alternatively be an unorganized schema and/or be otherwise structured. The object library can be maintained by a platform, by a distributed system, and/or by any other system.

The object library can include a set of data structures (e.g., object type, asset, spatial relationships, etc.). Each data structure type is preferably independently managed (e.g., stored in a separate database, updated independently, etc.), but can alternatively be managed together with another data structure type. In an example, the object type can be stored in a knowledge graph, the assets (e.g., 3D models) can be stored in an asset database, the spatial relationships can be stored in an embedding database, and/or any other data structure type can be stored in any other appropriate storage system. Independent management of the different data types can enable the system to be more modular. In an example, different object types can reference the same asset and/or use the same spatial relationship embeddings.

In variants, the object library can include: an object type; a 3D model (e.g., asset); animations; relationships; appearance; and/or any other data structure.

The object type functions to define parameter values (e.g., attributes, behaviors, etc.) for a type of object (e.g., object type, concept, etc.). The object library can define one or more object types, wherein each virtual scene can include one or more instances of one or more object types. Illustrative examples of object types (e.g., “concepts”) can include: a person, a car, a boat, a building, and/or any other object types.

Each object type can define a semantic concept (e.g., abstract concept, known entity, etc.), and can additionally or alternatively define additional information. The object type preferably represents a noun, but can alternatively represent a verb, adverb, adjective, and/or any other descriptor.

Each object type preferably does not define object geometries (e.g., assets), but can alternatively define object geometries. Each object type preferably does not define probabilistic or physical execution details (e.g., physical placement, animation data, geometry, etc.), but can alternatively define probabilistic or physical execution details.

Each object type can have a set of parameters (e.g., logic, descriptors, intent, etc.), wherein each parameter can take on a value.

The parameters can define inherent nature, behavior, and/or any other characteristics. The set of parameters can inject semantic information and structural definition into generative model queries, which can enforce structural coherence (e.g., conventionally difficult to achieve with raw, text-based prompts in standard generative models). The set of parameters can provide behavior and interactivity based on the semantic definitions attached to the object type. This can eliminate the need for manual scripting.

Different object types can have the same parameters (e.g., adhere to the same ontology) or different parameters. Different object types can have the same or different parameter values.

The parameter values are preferably descriptions (e.g., prose, text, video, audio, etc.) and/or qualitative, but can additionally or alternatively be numerical, quantitative, binary, categorical, and/or any other values. The set of parameter values can cooperatively define information that can be used to render an instance of the object type (e.g., in a frame, in a timeseries of frames, etc.), and/or be otherwise used.

All or portions of the parameter values are preferably expressed in natural language (e.g., which can enable the object types to be used by language models, enable the object types to be manually edited and introspected, etc.), but can additionally or alternatively be expressed by a set of embeddings in a latent space (e.g., semantic space, etc.), and/or otherwise expressed.

Each object type can include a set of default parameter values for the object type, a set of custom values (e.g., for an instance of the object type, and/or any other set of values). The parameter values can be manually specified, automatically generated by an LLM, retrieved from a third party source, learned, and/or otherwise determined. Different instances of an object (e.g., different object instances) can have the same or different parameter values for one or more parameters. The object type can be associated with default values for each parameter, entity-default values for each parameter, and/or any other values.

The object types can be: manually specified, automatically determined (e.g., added by a user, generated ad hoc), learned (e.g., from repeated user customization), randomly generated, determined using a set of rules, predicted using a neural network, etc.), and/or otherwise determined.

For example, new object types can be added to the object library on-the-fly (e.g., without an explicit user request to add the new object type, without the user specifying specific parameter values, etc.).

In a first example, when a new object type is identified (e.g., a described or requested object type does not have a direct match in the object library), the system can automatically determine parameter values for the new object type (e.g., new geometry, attributes, descriptions, etc. ; by querying a user or querying a large model to return the parameter values; etc.); identify a similar object type that already exists in the object library (e.g., by querying the user, by querying a large model to return the closest object type from the existing set of object types, by encoding the new object type into an embedding and finding a nearest neighbor existing object type, using cosine similarity, etc.); and create a new object type of the existing object type using the original parameter values and the determined parameter values (e.g., wherein the new object type inherits the existing object type's parameter values and overwrites any differences with the determined parameter values, etc.).

In a second example, the object library can receive a new object type with parameters specified by a user.

However, new object types can be otherwise defined.

The new object type can be treated as a child object type of the existing object type (e.g., a subclass), as a sister object type of the existing object type (e.g., inherit the existing object type's parent, be added as a sibling class), and/or be otherwise organized within the ontology and/or hierarchy.

In variants, the object type can include or define: an object type identifier; semantic relationships; abilities (e.g., behaviors); attributes; associated assets; associated animations; descriptions; logic; and/or other parameters.

The object type identifier functions to identify the object type (object class). The object type identifier can include: generic identifier or object type name, unique identifier or object instance name, and/or any other identifiers. The object type identifiers are preferably semantic and human-readable, but can alternatively be non-human readable (e.g., computer-readable, an encoding, etc.). The generic identifier can be automatically assigned (e.g., by a language model), manually assigned, and/or otherwise assigned. The unique identifier can be automatically assigned (e.g., based on other parameter values, by incrementing an index for each instance of the object type, etc.), manually assigned, and/or otherwise assigned. However, the object type identifier may be otherwise configured.

The semantic relationships function to define explicit, ontological structures between the object type and other object types (e.g., contains, found with, found on, found where, found when, part of, etc.). For example, the object library explicitly knows that a “forest” contains “trees” and “bushes”. The semantic relationships can provide realism by defining co-occurrence between object types. The semantic relationships can cooperatively define a hierarchical, ontological structure. Child concepts in the hierarchy can inherit parameter values of the parent concepts.

In a first example, a “motorcycle” inherits the core ability to be piloted and the control interface from its parent “vehicle” class.

In a second example, “Zombie” can be defined by associating it with the “Humanoid” character class, and designating it in an “enemy” role, collating attributes against that entire branch.

The hierarchical, ontological structure can include categories, classes, subclasses, and/or any other organizational elements. The ontological relationship (e.g., the edge) can be associated with a set of parameter values, such as density, scale, color, rotation, randomness, distribution type (e.g., random distribution, grid distribution, etc.), and/or other ontological parameters. In variants, the set of object types can be represented as a knowledge graph or hierarchical structure.

However, the semantic relationships may be otherwise configured.

The abilities (e.g., behaviors) function to define the core interaction logic for the object type. Each ability can be associated with a control model (e.g., that controls the sequence of motions for the ability), and/or any other model. The control model can be a physics-based model (e.g., physics simulator, PDE-based simulator, FEA simulator, etc.), animations, scripted responses (e.g., reactions, etc.), a set of rules, and/or any other model. The abilities (e.g., behaviors) can include a predetermined set of interaction rules (e.g., humanoid objects will default to sitting on a seat if placed on a chair object), states (e.g., run, walk, jump, etc.), specific actions, references to specific animations (e.g., associated with the states or actions), and/or other abilities. The abilities (e.g., behaviors) can be selected, generated, and/or otherwise determined based on the values of other parameters, and/or independent of other parameter values. The abilities can include (e.g., encode): behavioral definitions (e.g., a chair or furnishing is used for the action of sitting); explicit relationships (e.g., an explicit link between a “chair” object type and the character action of “sit”; an encoding connecting the object type and action; an explicit link between the character pose and the object type; etc.); semantic interoperability (e.g., the chair's behavior defined as “when you place a character near a chair, the character will want to sit on me”); and/or other information. The abilities (e.g., behaviors) can be automatically called when detected in a prompt (e.g., user request, user query, etc.). The abilities can be used when the ability is detected in a natural language prompt (e.g., “the character sits down”, where the ability is “sit”), in a structured request (e.g., “character. ability(sit)”), and/or otherwise detected.

For example, a concept like “Zombie” can be defined as an “enemy NPC” with default artificial intelligence behavior (like patrol and attack), enabling interactivity. In another example, a chair can know it connects to the character action “Sit”, and a character can know it connects to a seating object region associated with the character action “sit”. This can provide interactive capability and functionality for free, based on the platform's semantic understanding of the scene construct and the author's intent (e.g., from the prompt). This is in contrast to conventional tools, where a user would have to manually script the character's movement (e.g. specify the path and set of intervening poses).

In an illustrative example, the platform will automatically have the character (associated with an object type with the action “sit” in the knowledge graph) walk over to the chair and sit down on the chair's seat when “sit”, a conjugation thereof, or a synonym thereof is detected in the prompt (e.g., “the character sits down”). In variants, this can be accomplished by: detecting the ability reference for a first object instance in the prompt; determining secondary object types associated with the ability (e.g., from the first object instance's object type in the knowledge graph); identifying secondary object instances with the secondary object type in the scene construct; determining a target pose based on the ability; and automatically generating a path and a set of poses from the first object instance's current pose to the target pose, optionally using a set of automations retrieved based on the ability. The path and set of poses can be generated when constructing the scene construct, when rendering the scene, and/or determined at any other time. The path and set of poses can be computed (e.g., based on physics), predicted (e.g., using a neural network), and/or otherwise determined.

Other examples of abilities can include movement (e.g., basic locomotion, climb, swim, pose, etc.), actions (e.g., Attack, Collect, Use Item, etc.), and/or behaviors (e.g., enemy patrol & attack, a ball bouncing when dropped, a zombie will always run toward the nearest human in the scene, etc.). However, the abilities (e.g., behaviors) may be otherwise configured.

The attributes function to define the concept's static qualities, which are then used by generation algorithms. For example, for environmental concepts (e.g., a forest), these include parameters like density, scale, rotation, color, and rotation random factors, which inform how the assets are distributed within the scene. Other examples of attributes can include: player type, gender, age, health, attack power, and/or any other attributes.

However, the attributes may be otherwise configured.

The associated assets function to identify which 3D model (e.g., asset) to use when populating a 3D scene with an instance of the object type. The associated assets can include a reference to a model within a 3D model database, can include the 3D model itself, and/or otherwise identify a 3D model to use. Each object type preferably identifies a single associated asset (e.g., a single 3D model), but can alternatively identify a class of assets, multiple assets, and/or any number of assets. In a first example, the referenced associated asset is the asset used to represent the instance of the object type (the object instance) within the 3D scene. In a second example, the object type can reference a proxy asset (e.g., for scene population), wherein the user can provide a custom asset that later replaces the proxy asset in the 3D scene. However, the associated assets may be otherwise configured.

The associated animations function to identify which animation to use. The associated animations can include a reference to an animation (e.g., an animation identifier), can include the animation itself, and/or otherwise identify the animation. Each object type can be associated with one or more animations. Different animations can be connected to different abilities, disconnected from abilities, and/or otherwise related to other object type parameters. Each ability can be associated with one or more animations (e.g., based on different conditional logic, be associated with different animation options for the same behavior, etc.). However, the associated animations may be otherwise configured.

The descriptions function to provide qualitative descriptors for the generative model; can additionally or alternatively be used to determine parameter values for other parameters. The descriptions can include semantic descriptors, qualitative descriptors, and/or any other descriptors. In an example, descriptions can include the object instance's backstory, personality, appearance, and/or any other descriptor. The descriptions are preferably for the object instance, but can alternatively be for the object type (e.g., be a default description). The object descriptions can describe how the visual appearance of the object should be rendered, how the element should interact with other elements, and/or describe other parameters of the object instance. The object descriptions are preferably specific to an object instance, but can alternatively be applied to all objects of the same type (or part of the same object type hierarchy) in the scene.

The descriptions are preferably a freetext, natural language description, but can additionally or alternatively include a structured input and/or any other input. Examples of structured inputs that can be used can include: key-value fields, forms, JSON, tables, symbolic language, restricted natural language with fixed vocabulary and syntax, parametric inputs (e.g., fixed selection options, numeric values, checkboxes, etc.), LoRAs (e.g., the LoRA itself or a reference to an external LoRA), a reference image, and/or other structured inputs.

The descriptions are preferably empty for the object type; alternatively, the object type can have a default description. The descriptions are preferably empty for an asset; alternatively, the asset can include a default description.

The descriptions are preferably specified by user (e.g., through a scene query), but can alternatively be specified by a language model (e.g., that parses the scene query), and/or otherwise specified. The descriptions can be generated by a user (e.g., wherein a user enters the description for a specific object instance, such as “elf with long ears and a pink shirt”); generated by an LLM (e.g., wherein the LLM generates lower-level details when given a prompt, such as an elf's appearance when prompted to generate a fairytale scene); be a default description; and/or otherwise determined in any other manner.

However, the descriptions may be otherwise configured.

The logic functions to determine when specific parameter values should be used. In an example, the logic can be conditional logic for when to use which parameter value set, and/or any other logic. However, the logic may be otherwise configured.

However, the object type may be otherwise configured.

In operation, the object types are used to define object instances (e.g., an instance of an object type), wherein the object instances are included in the scene constructs.

The parameter values of individual object instances (e.g., in a virtual scene) can be inherited from the object type′ default values for one or more of the parameters, be specified by a user, be automatically generated (e.g., randomly selected, values generated by a generative model, values predicted by a neural network, etc.), be learned (e.g., from existing media, video, visual assets, etc.), and/or be otherwise determined. In an example, a “health” parameter can take on a “good health” value or an “8” value on a health scale of 0-10. Each object instance can be associated with the same parameter value set for all frames of the visual media (e.g., film, video, etc.), but can alternatively be associated with different parameter value sets (e.g., the appearance or behaviors change over time).

In a first variant, the parameter values for an object instance can be default values.

In a second variant, the parameter values for an object instance can be user selected.

In a third variant, the parameter values for an object instance can be generated by a generative model, based on a user description. In an example, a user can describe an object instance's behavior, personality, and/or appearance using a text description (e.g., prose), wherein the text description is passed to the generative model when generating the object instance's visual appearance.

However, the parameter values for an object instance can be otherwise defined.

The 3D models (e.g., asset) of the platform function to define an asset geometry, and can be used as a backend representation of the object for scene building and/or manipulation. The 3D model (e.g., asset) can be considered fungible across different object types, but can alternatively be specific to an object type.

Each object type preferably maps to a single 3D model (e.g., identified in the object type's parameter set), but can alternatively map to multiple 3D models. The different 3D models for an object type can vary in geometry, subcomponent connections (e.g., joints, degrees of freedom, etc.), and/or otherwise vary. Each 3D model (e.g., asset) can be shared by one or more object types (e.g., associated with a parent class and the respective child classes, associated with multiple classes of the same hierarchy, etc.) and can be treated as separate from the object types, which breaks the traditional relationship between logic and the object geometry.

The 3D models can have semantic identifiers, nonsemantic identifiers, or be unnamed. The 3D models can be mapped to a nearest neighbor object type in the knowledge graph (e.g., based on the respective identifiers/names; based on a large model-predicted description of the 3D model; etc.), manually associated with the object type in the knowledge graph, associated with an object type via a predicted mapping (e.g., by an LLM, based on the object type and asset names, etc.), and/or otherwise determined.

The 3D model can be stored in an asset database (e.g., a separate database from the object types, or be stored in the same database), in the knowledge graph, or otherwise stored. In variants, the 3D models (e.g., assets) can be stored separately from the object library, wherein different object types reference one or more 3D models to use when populating an instance of the object type into the virtual scene.

The 3D model (e.g., asset) preferably does not include color appearance (e.g., uncolored), but can alternatively include color appearance (e.g., colored).

Each 3D model can include multiple different models or geometric representations of the same object in different poses and under different conditions, wherein a geometric representation from the set is dynamically selected when rendering the 3D model in the scene. Alternatively, each 3D model can be associated with a single model.

The 3D model (e.g., asset) can be: a hull, a mesh, a set of anchor points, a geometric embedding (e.g., in a geometric latent space, a spatial latent space, etc.), a set of boundaries, a skeleton (e.g., hierarchy of joined armatures independent of or associated with a mesh), a rig (e.g., an animation control system built on top of a skeleton, can include constraints, controllers, IK handles, drivers, custom attributes, etc.), code, a low-rank adaptation (e.g., LoRA for geometry), a Gaussian splat or components thereof (e.g., the covariance matrix, etc.), and/or otherwise represented.

The 3D model (e.g., asset) can be: manually determined (e.g., manually drawn or constructed, etc.), automatically generated (e.g., by a generative model prompted to output a geometry of the object type), uploaded, scraped, predicted (e.g., using an image-to-hull or image-to-3D model), and/or otherwise determined.

The 3D model (e.g., asset) can include: a default model (e.g., default asset), one or more custom model(s), and/or any other models. The default model (default asset) can define the default asset to use to represent the object in a virtual representation of the scene.

However, the 3D model (e.g., asset) may be otherwise configured.

The animations function to define the mechanics of a given 3D model (e.g., a set of object geometries, how the object geometry changes over time, and/or any other suitable mechanics).

The animations are preferably associated with a 3D model (e.g., asset), but can alternatively be associated with an object type and/or any other data entity. The animation is preferably specific to a 3D model, but can alternatively be shared across 3D models. The animations are preferably shared across object types (e.g., fungible across object types), but can alternatively be specific to an object type. Each object type can be associated with one or more animations, but can alternatively be associated with no animations.

The animations are preferably associated with one or more abilities (e.g., object type behaviors), but can additionally and/or alternatively be associated with no abilities. Different animations can be associated with different ability-asset permutations, but alternatively the same animation can be associated with different ability-asset permutations.

In a first example, “walk” can be associated with a first animation for a quadruped asset and be associated with a second animation for a humanoid asset.

In a second example, “drive” can be associated with a first animation for a humanoid asset and a second animation for a vehicle asset.

The animations can be a static geometry (e.g., “sit”, “stand”, etc.) or a dynamic timeseries of geometries (e.g., “walk”, “run”, “drive”, etc.). Animations can include a series of poses, series of interactions with other objects, animation graphs, state machines, runtime solvers, articulation models, rigs, controls (e.g., controllers, manipulators, etc.), deformations (e.g., controlling mesh deformations, blendshapes, corrective shapes, etc.), physics models (e.g., set of partial differential equations, a neural network trained on physical phenomenon, etc.), constraints, procedural motion (e.g., ragdoll physics), code, set of keyframes, and/or other animation representations. Animations can include macro animations (e.g., animations of the macro components of an object, such as arms, bodies, etc.), micro animations (e.g., animations of object features, such as facial expressions, ear movements, hair movement, etc.), and/or other animations.

The animations can be modified by the parameter values of the object type, and/or be otherwise customized. In an example, new rig code or a set of controller code changes can be automatically generated based on the object type's parameter values (e.g., using a language model, generative model, etc.), and used to modify the rig code for the base animation.

The animations are preferably stored in the asset database, but can additionally or alternatively be stored in the object type knowledge graph and/or in any other storage structure.

The animations can be associated with different descriptors, visual indicators (e.g., icons, names, titles, etc.).

The animations are preferably passed directly to the generative model, but can alternatively be not passed to the generative model (e.g., wherein the animation is skinned using the output of the generative model) and/or otherwise used.

In a first variant, the animations (e.g., object configuration changes over time, series of object poses, etc.) can be explicitly modeled as part of the 3D scene representation (e.g., wherein the scene includes a set of animated 3D models). In this variant, a series of still frames of the scene can be individually captured and individually rendered (e.g., appearance-rendered, textured frame, shaded frame, appearance-conditioned frame, colorized, appearance injected, edited, transferred, etc.) by the generative model.

In a second variant, the animations can be described (e.g., as expressions, such as “she grimaced”; as verbs, such as “wind flowed through his long hair”; etc.) as text, as video, or in any other modality. In an example of the second variant, the animation can include a description of how the object type should be animated (e.g., “grimacing will cause the nose to wrinkle and the lip corners to raise up”).

In the third variant, the animation descriptions can be passed to the generative model with a reference frame of the 3D scene, wherein the generative model animates the objects during rendering.

In an illustrative example, direct object instance animations (e.g., modeling an object instance dancing) can be passed directly to the generative model (e.g., as a series of 3D representation frames), while animated expressions (e.g., happy, sad, fearful, etc.) are not directly animated as part of the 3D representation, but are passed as instructions or script to the generative model, wherein the generative model interprets the instructions and generates the object instance's visual appearance (and/or modify the object instance's geometric configurations) based on said instructions.

However, the animations may be otherwise configured.

The relationships function to define how the object type interacts with other object types in the scene. The relationships can define relationships that are not explicitly encoded in the object type (e.g., probabilistic relationships, relationships that are not included in the knowledge graph, etc.), and/or other relationships.

The relationships can include physical relationships, relative pose, relative scale, interaction type (e.g., sit, lean, etc.), conceptual relationships (e.g., parent, child, etc.), semantic relationships, co-occurrence, and/or other relationships between the object instance and the virtual environment.

The relationships preferably define spatial relationships (e.g., between object types, assets, etc.), but can alternatively define interaction relationships (e.g., conditional relationships), cooccurrence relationships, and/or other relationships. Spatial relationships can inform object placement, grouping, pose, and/or other spatial relationships. Cooccurrence relationships can define which other object types should be included in the scene (e.g., even when the object type is not explicitly identified in the query or initially identified based on the query).

In examples, relationships can include: location, other objects (e.g., in the same or different branch) that the object is associated with (e.g., “trees” are found with “bushes”), predetermined interactions with other scene elements (e.g., object will sit on the boat's thwart when the object is specified to “sit” on the boat).

The relationships can be associated with one or more object types, assets, and/or any other elements. Each object type and/or asset class can be associated with a set of physical relationships with other object types and/or asset classes. For example, “couch” can rest on the same plane as a table and be spaced apart from the table by a predetermined distance (e.g., 3 feet); can be next to a potted plant; and can be located underneath a humanoid.

The relationships are preferably stored independently from the object type and 3D models (e.g., assets), but can alternatively be stored as part of the knowledge graph, as part of the asset database, and/or otherwise stored. The relationships are preferably stored in a relationship database (e.g., a vector database, set of embeddings, etc.), but can otherwise be stored.

The relationships can include and/or be defined by: rules, descriptions, physical relationships (e.g., physical connections, such as which components should touch), semantic relationships, conceptual relationships, embeddings in a latent space (e.g., in a vector embedding space, an encoder's output latent space, etc.), and/or any other relationships.

In a first example, the embeddings can represent the object type and/or asset, wherein the embedding position in the latent space can specify how the object type and/or asset are related to each other.

In a second example, the embeddings can represent how the relative poses of the object types and/or assets themselves.

The relationships can be learned (e.g., by observing user actions, co-occurrence patterns, user edits, foundational model feedback, etc.), explicitly specified, and/or otherwise determined.

One or more of the relationships can include probabilities, weights, and/or other relationship representations. The relationship representations can be used to select which relationship to populate into the scene construct (e.g., how to pose a given object instance's asset), to identify other object types that should be populated into the scene construct, and/or otherwise be used.

In an example, “sofa” can have a 99% probability of being in a “living room”, “cat” can have a 50% probability of being in a “living room”, and “ocean” can have 0% probability of being in a “living room”. In use, the system can identify that a sofa should be populated into the scene construct when populating a living room, may populate a cat when populating the living room, and will not add an ocean when populating the living room (unless explicitly specified by the user).

However, the relationships may be otherwise configured.

The appearance functions to define the appearance (e.g., materials, textures, lighting, optical properties, etc.) of the object type. The appearance value is preferably stored as part of the scene construct and not as part of the object type, asset, or other data structure. Alternatively, the default appearance values can be stored as part of the object type, asset, as a separate data structure (e.g., that is independently identified by the object type, object instance, etc.).

The appearance value for the object type is preferably null (e.g., appearance is not stored as part of the knowledge graph), empty, or a default value for all object types, but can alternatively be a non-null or unique value. The appearance value for an asset is preferably null (e.g., appearance is not stored as part of the asset database), but can alternatively be a default value, non-null value, a unique value, and/or any other value. The appearance value is preferably not null for an object instance (e.g., is defined by a text descriptor, a LoRA, etc.), but can have any other value. The appearance is preferably defined on a per-object instance basis (e.g., each object instance in the scene is associated with an appearance value that was determined for that specific object instance), but can alternatively be defined for the object type, the asset class, and/or otherwise defined.

The appearance can be determined by a generative AI model (e.g., by an LLM, by a VLM, etc. ; from an object instance description; etc.), specified by the user, randomly determined, or can alternatively be otherwise defined.

The appearance can include a set of predefined appearances (e.g., “red Ferrari”, “blue Ferrari”, etc.), a single predefined appearance, a custom appearance, and/or any other appearance.

The appearance is preferably merged with the 3D scene representation (e.g., a frame) by the generative model (e.g., wherein the generative model renders the appearance based on the 3D scene reference to generate the appearance-rendered frame), but can alternatively be included by default when building the 3D scene, and/or otherwise applied. When rendering the scene (e.g., rendering the frame), the generative model can:
adhere strictly to the 3D model (e.g., the appearance pixels fill the boundaries specified by the 3D model); be bounded by the 3D model (e.g., does not exceed the boundaries of the 3D model but does not have to fill the 3D model boundaries); exceed the 3D model (e.g., bleed beyond the 3D model boundaries); and/or be otherwise related to the 3D model.

However, the appearance may be otherwise configured.

However, the object library can include any other set of components.

All or portions of the object library can have a flat architecture, a graph architecture, a hierarchical structure (e.g., wherein child object types inherit all or portions of the parent object types'parameter values), and/or any other architecture. For example, the set of object types can be arranged in a graph-based architecture that defines a hierarchical set of object types (e.g., a knowledge graph). The hierarchy can be organized semantically (e.g., in semantic space, conceptual space, etc.), ontologically, taxonomically, and/or any other organizational approach. In an example, nodes can represent object types (e.g., with the associated parameters and values) and edges can represent relationships between object types. In an example, “sofa” can be connected to “living room”. Child object types can inherit the properties of parent object types, or not inherit parent properties.

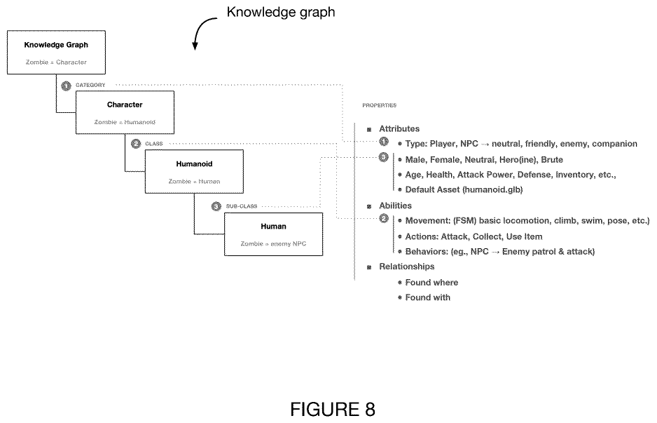

An example of the knowledge graph and ontology is shown in FIG. 8.

In an example, the knowledge graph can include a set of object categories, wherein each object category includes a set of object classes, wherein each object class includes a set of object subclasses. Each object category, object class, and object subclass can include a set of attributes, abilities, and/or relationships, wherein children object types inherit the attribute, ability, and/or relationship values from the parent object types. In an illustrative example, a city block can include subobjects of buildings, sidewalks, pedestrians, street signs, traffic lights, trash cans, all with predefined (e.g., default) poses, behaviors, and/or other predefined parameters.

The knowledge graph can encode explicit relationships between object types, which can be used to automatically populate the scene construct with instances of relevant object types. In an example, “sofa” can be connected to “living room” in the knowledge graph.

Additionally or alternatively, all or portions of the object library can optionally include or be used with an embedding database, which can store the relationships (e.g., spatial relationships, probabilistic relationships, etc.) and/or other information.

The embedding database can function to encode probabilistic properties of the objects that are not explicitly stated in the knowledge graph. The embedding database can complement the explicit relationships (e.g., contains, found in, found with) stored in the object parameters by providing looser, statistically-derived associations between concepts. The embedding database can be a vector database and/or have any other structure. The system can include one or more embedding databases (e.g., for different domains). The embedding database can store vectors of: features (e.g., human-readable features, handcrafted features, etc.), embeddings in a latent space (e.g., latents, etc.), and/or vectors of other information.

The vectors can describe relationships between object types, assets, animations, and/or any other elements. The vectors in the embedding database can be determined based on: spatial relationships between object types in a final scene construct; object type co-occurrence in scene constructs; and/or other information. The vectors can encode co-occurrence, positional relationships, semantic relationships, and/or any other relationships. In an example, the vectors can be used to determine that a family picture frame should appear next to a table lamp on an end table beside a couch (e.g., wherein the embeddings for the family picture frame, table lamp, end table, and couch are collocated in the latent space and/or have less than a threshold vector distance from each other). In an example, commonly collocated objects can be embedded proximal each other in the latent space.

The latent space used by the vector database (e.g., the space that the vectors, embeddings, or latents are within) can be a spatial latent space (e.g., that encodes spatial relationships), semantic latent space (e.g., that encodes semantic co-occurrence), multidomain latent space (e.g., both semantic and spatial), and/or be any other latent space. The latents in the latent space are preferably non-human readable, but can additionally or alternatively be human-readable.

The vectors within the embedding database are preferably generated by an encoder, but can alternatively be otherwise determined. The encoder can be a pretrained encoder, an encoder from a trained larger model (e.g., autoencoder, classifier, etc.), an encoder from an autoencoder (e.g., trained to encode the physical relationships or descriptions thereof between object types into a latent space, then decode the resultant latents back into the physical relationships or descriptions thereof; etc.), a set of encoding layers (e.g., from a CNN, DNN, RNN, transformer, diffusion model, etc.), an encoder trained to minimize the vector distance between similar concepts or positions, and/or any other set of encoding layers. The encoder and/or latent space can be trained on user-defined scene constructs, existing media (e.g., imagery, video, etc.), and/or other training data to learn the inter-object relationships.

The inputs to the encoder can include: text descriptions, inter-3D model relationships, the object type, the asset (e.g., 3D model), object instances and/or parameters thereof (e.g., wherein the encoder encodes the set of parameter values for each object instance, etc.), and/or other information into the latent space.

The inputs can include all object instances in the scene, the objects proximal the target object instance in the scene, only the target object instance, and/or any other set of inputs

The relationship between the input and other objects can be determined based on: the distance between the respective object embeddings, the directionality between the respective object embeddings, the difference between the respective object embeddings, the embedding itself (e.g., wherein “chair” is decoded into “underneath table” without knowledge of whether a table is present in the scene), and/or otherwise determined.

However, the object library may be otherwise configured.

The scene construct functions to represent a virtual world (e.g., scene). In an example, the scene construct serves as a container for 3D objects that are semantically defined by concepts from the object library. The scene construct can include the semantic information about the scene, the 3D information about a scene, and/or other information about the scene. The scene construct can be constructed from instances of assets associated with object type instances pulled from the object library (e.g., the knowledge graph, the asset database, the relationship database, etc.). The scene construct can be constructed using a set of queries or requests, generated from a sample (e.g., from an image, a video, a model, etc.), manually generated (e.g., using drag and dropped assets associated with object types), and/or otherwise generated.

In a first example, a user can enter “populate a dark forest”, wherein the system can populate instances of object types associated with forests (e.g., fauna, flora, etc.) into the scene construct, “an elf is walking through the forest”, wherein the system can populate an instance of a humanoid with elf ears and a staff into the scene construct, and “remove the staff”, wherein the system can remove the staff from the scene.

In a second example, objects can be identified within a provided image (e.g., using an object detector, instance-based segmentation module, etc.) and used to identify objects from the object library to include in the scene construct. A depth map can be generated from the image (e.g., predicted from the image) and used to determine the parameter values for the objects. The scene construct is then generated from the objects and their parameter values (e.g., default values or extracted values).

The scene construct is preferably not displayed to the user, but can alternatively be displayed to the user.

Each user project can include one or more scene constructs.

In variants, the scene construct includes: a 3D scene; a set of virtual cameras; a scene context, and/or other elements.

The 3D scene of the scene construct can function to describe the geometric composition of the scene. The 3D scene can include a collection of 3D models (e.g., assets) for each of the object instances in the scene. The 3D scene preferably only includes geometry information (e.g., shapes, volumes, relative poses, etc.), but can additionally or alternatively also include visual appearance (e.g., be appearance-rendered) and/or other information.

The 3D scene preferably lacks appearance, such as optical and/or material properties (e.g., wherein the generative model generates the appearance of each object instance based on the respective 3D model and associated parameter value set), but can alternatively include an appearance (e.g., by a previous generative model run, using default appearance values, etc.), and/or any other appearance state.

In variants, the 3D scene includes a set of object instances (e.g., concept instances, entities, etc.). Each object instance (e.g., instance of an object type) is represented by a different 3D model instance (e.g., asset instance) in the 3D scene, or be otherwise represented. Each object instance can be associated with a set of parameter values for the respective object instance.

The parameter value set for each object instance can be defined by the user, learned, predicted (e.g., by a large model), be a set of default values, and/or otherwise determined. The set of parameter values for each object instance can include: scale, interaction parameters, attributes, descriptions (e.g., character backgrounds, etc.), a pose within the scene (e.g., relative to a scene reference point, relative to another object, etc.), and/or any other set of parameter values. The parameter value set can additionally or alternatively include explicit object relationships (e.g., which objects are registered together, which objects should move together, etc.).

In an example, a human asset within a vehicle asset is registered with the vehicle asset, such that the human asset moves within the 3D scene when the vehicle asset moves.

In variants, object instance assets can be registered to a specific location of the other object instance asset (e.g., the closest location on the other object instance asset, a predetermined location on the other object instance asset, etc.), maintain a user-defined pose, and/or be otherwise registered. Object instance assets can be registered by a user (e.g., wherein the user drags and drops a first object onto a second object; wherein the user textually specifies the first and second objects'respective poses; etc.), automatically registered (e.g., based on registration rules from the knowledge graph), and/or otherwise registered.

The set of object instances in the scene construct can be stored as a graph (e.g., scene graph), list, description (e.g., detailed written description of the scene using a template or systematic set of descriptors), and/or using any other suitable object set representation. In an example, nodes in the graph can represent individual object instances (e.g., with node-specific parameter value sets), and edges can represent relationships between the object instances (e.g., semantic relationships, physical relationships, etc.).

However, the set of object instances (e.g., concept instances, entities, etc.) may be otherwise configured.

However, the 3D scene may be otherwise configured.

The set of virtual cameras of the scene construct functions to provide various perspectives of the 3D scene. The set of virtual cameras can be placed randomly, by a user within the scene (e.g., by dragging and dropping), using a prompt (e.g., “viewing the car from above”), and/or otherwise placed. The set of virtual cameras can be static or move through the scene over time (e.g., be associated with a trajectory or camera path through the 3D scene). The set of virtual cameras can include a set of camera parameters, such as focal length, field of view, filters, resolution, distortion, aperture, shutter speed, depth of field, white balance, and/or other camera parameters. The camera parameters can be manually determined, determined by an agent (e.g., an LLM, a generative model, a DNN, etc.), be predetermined (e.g., default values, predefined trajectories associated with a cinematographic style, etc.), and/or otherwise determined. However, the set of virtual cameras may be otherwise configured.

The scene context of the scene construct functions as a semantic descriptor of the scene. The scene context can be used to provide consistency across rendered frames (e.g., by rolling up the scene and object concepts, aesthetic requirements, positional data, and/or other information into a single, comprehensive descriptor).

The scene context can include object instance parameter values, spatial parameter values, scene parameter values, and/or any other parameter values.

The object instance parameter values can include parameter values (e.g., object type, unique identifier, descriptions, etc.) for each object instance in the scene. The object instance parameter values can be received from a user (e.g., wherein the user selects an object instance and enters an appearance description, backstory, or other descriptor for the object instance), retrieved from the knowledge graph (e.g., include a set of default parameter values), retrieved from the relationship database, and/or otherwise determined.

The spatial parameter values can define the spatial arrangement of different object instances (e.g., whether the object instance is in the background, mid-ground, foreground, etc. ; relative position in the scene; etc.).

The scene parameter values (e.g., scene descriptions) can include visual style, time of day, lighting, image qualifiers (e.g., soft, diffuse, neutral, etc.), cinematographic or technical qualifiers (e.g., resolution settings, output format, camera details), and/or any other scene parameter values. The visual style can include aesthetics such as film noir, sci fi, horror, and/or other visual styles. The scene parameter values can be default values, values received from a user, predicted by a large model (e.g., LLM, VLM, etc.) based on a user prompt, inherited from the project or the environment, and/or otherwise determined. The scene parameter values can be specific to a scene, inherited from a project (e.g., wherein the project includes the scene), and/or associated with any other data structure.

The scene context can optionally include or be paired with a 3D scene reference (e.g., 2D reference frame, 2D reference image, reference mask, etc.). The 3D scene reference can be a 2D projection of the scene onto a virtual camera, or otherwise determined. The 3D scene reference can be used by the generative model to determine which regions to render in (e.g., infill). Each object instance region in the 3D scene reference (e.g., object instance segment, object instance pixels, etc.) can be associated with a unique object instance identifier. Alternatively, the object instance region can be unlabeled, wherein the scene context can uniquely identify which object instance region should be infilled based on which object instance description, or be otherwise identified.

The scene context can be generated from and/or include the parameter values of each object instance represented by the asset instances in the 3D scene (e.g., unique identifier, appearance description, object type, etc.), the spatial relationships of the object instances, the edit history (e.g., of user actions, the set of user prompts, etc.), a set of scene parameters (e.g., lighting, style, etc.), runtime state, and/or any other information. The scene context can be generated for the scene as a whole, individual virtual camera contexts (e.g., for everything visible in a camera's view frustum), and/or any other portion of the scene.

In a first variant, the scene context can be determined using a scene summary agent. The scene summary agent can audit everything currently in the camera view, and can account for current object instances, their spatial and conceptual relationships, their parameter values, the history of user actions on each object instance, and/or other information on a per object basis for each visible object instance.

In a second variant, the scene context can be determined using a secondary large model (e.g., LLM, VLM, etc.), wherein the secondary model is passed a 3D scene reference (e.g., 2D reference image) of the scene (e.g., sampled by the virtual camera) with the text metadata for the visible object instances. The secondary model can generate a structural scene descriptor (e.g., in natural language, etc.).

However, the scene context can be otherwise determined.

The scene context can be used by the generative model to render the appearance-rendered frame, used to compose the 3D scene based on a user's prompt, be provided to the user to explain the scene, and/or any otherwise used. In an example, the scene context can be combined with a set of geometric references generated from the 3D scene to ensure that the generative model's output adheres to the 3D structure (e.g., using a set of ControlNets, etc.). The geometric references can include a 2D reference image (e.g., flat frame snapshot), a depth map, Canny data (e.g., edge maps, outlines of the elements, element segments, etc.), and/or any other geometric representation that imposes geometric constraints.

However, the scene context may be otherwise configured.

However, the scene construct may be otherwise configured.

The set of agents functions to convert a user input (e.g., query) into a set of platform actions and/or outputs. Examples of platform actions can include: determining a set of object instances, generating a scene construct, generating prompts for downstream large models from the scene construct (e.g., LLM prompts, generative model prompts, etc.), rendering a set of frames for the scene construct, using the set of prompts, optionally generating a video from the set of frames, and/or other actions.

Examples of determining the set of object instances can include selecting object types, optionally determining the object instances to populate (e.g., based on the object type parameter values, etc.), setting parameter values (e.g., descriptions, ability selections, etc.) for the object instance (e.g., descriptions, etc.), retrieving assets for each object instance, populating the retrieved assets into a 3D scene, associating the parameter values with each asset for the respective object instance, and/or otherwise determining the set of object instances.

Examples of generating the scene construct can include: populating a 3D scene with the set of retrieved assets, generating descriptions for the scene (e.g., scene context, backstory, per-object instance summary, etc.), and/or otherwise generating components of the scene construct.

Each agent can include one or more: LLMs, VLMs, foundation models, generative models (e.g., diffusion models, etc.), transformers, neural networks (e.g., with one or more hidden layers), CNN, DNN, RNN, rule-based model, a subset of a model (e.g., the encoder from an autoencoder, the decoder from an autoencoder or transformer, etc.), game engine, deterministic models (e.g., physics model), and/or any other suitable model. The agents are preferably probabilistic models, but can alternatively be deterministic models or otherwise configured. In examples, agents can encode the model input into a different domain (e.g., a latent space, learned through model training, etc.), then convert (e.g., decode, predict, match, lookup, etc.) the latent encoding into a model output.

The agent models can be: fine-tuned, pretrained for a generalized application (e.g., a generalized LLM, such as ChatGPT, Claude, etc.), trained for the specific application, handcrafted, and/or otherwise generated. Each agent can include a single model, a single model operating in different roles (e.g., using different conditioning prompts, such as “act as a storyteller”, “act as an animator”, etc.), an ensemble of models, and/or any other combination of models. The set of agents can be predetermined, defined by a user, and/or otherwise configured.

The platform can include one or more agents. Different agents can be specific to different workflow tasks, different styles, different object types, and/or otherwise specific or generic. The platform can include one or more of the same or different agent types (e.g., for different use cases, different scene construct values, different users, etc.).

The agents can treat the data structures (e.g., knowledge graph, asset database, relationship database, etc.) as tools or resources, be specifically tailored to the data structure (e.g., be specifically built to traverse a knowledge graph or an embedding latent space, etc.), or be otherwise constructed.

In variants, the set of agents can include: an interpretation agent; a populator agent (e.g., scene composer); a scene summary agent; a style agent; a prompting agent; a verification agent; a composer agent; and/or any other agent.

The interpretation agent functions to parse user prompts into concepts, optionally separate known from unknown concepts, correlate the identified concepts to the object types within the object library, generate parameter values or parameter value changes for new concepts (e.g., that are not in the set of existing object types), generate object instance descriptions, and/or any other suitable functions.

In operation, the interpretation agent can receive the user prompt, determine a set of object instances based on the user prompt, generate descriptions for the determined object instances, determine object instance parameter values for the determined object instances, generate new object types when the identified object type is not in the object library, optionally identify which assets to retrieve from the object library (e.g., the asset database), and/or optionally determine the spatial relationships between the identified object instances.

The determined set of object instances can include: an object type, optionally parameter values (e.g., abilities, attributes, numerosity, spatial distribution, etc.), and/or other information. The determined set of object instances is preferably the highest-level relevant object type in the object type hierarchy, but can additionally and/or alternatively include one or more of the subclasses underneath the highest-level object type. For example, the interpretation agent can identify “tropical forest” when the user prompt includes “hut in the middle of the Amazon”. The object instance descriptions are preferably from the interpretation agent's parametric memory, but can alternatively be retrieved and/or summarized from third-party sources (e.g., Wikipedia, other databases), collated from parameter values (e.g., from the respective object type, the relationships database, etc.), and/or otherwise determined.

The object instance's parameter values can be collated from the whole branch of the object instance's object type (e.g., from the node and all parents, from the node and all children, etc.); be generated de novo by the interpretation agent (e.g., predicted from the query); and/or otherwise generated.

In a first variant, the object instance's parameter values can be retrieved for the respective object type from the object library (e.g., the knowledge graph).

In a second variant, the object instance's parameter values can be extracted from the prompt. For example, the agent can interpret “put the user next to the boxes” to output a specific position of the user within a scene (e.g., with knowledge of where the boxes were placed).

However, the interpretation agent can be otherwise configured.

In a first variant, the interpretation agent includes a foundational model (e.g., LLM, VLM, etc.). The foundational model can: identify new concepts (e.g., identify that the concept is not already within the object library); classify new concepts (e.g., identify which existing object type is the closest to the new concept, determine the new parameter values for the new object subtype, etc.), create system instructions (e.g., to update object instance locations in the scene, animations, etc.), create runtime code (e.g., new behaviors, etc.), and/or perform other functionalities.

In a second variant, the interpretation agent can include a fine tuning model and a foundational model (e.g., LLM). The fine tuning model can provide context for the foundational model. The fine tuning model is preferably not a fine-tuned model, but rather provides refined context. Alternatively, the fine tuning model can be a fine-tuned model. The interpretation agent is preferably not a fine-tuned model, but rather provides refined context, but can alternatively be a fine-tuned model. The fine tuning model can parse the knowledge graph to identify the most relevant object types (e.g., concepts and properties) and collate the parameter values to provide specific semantic context to the foundational model. In an example, the fine tuning model can identify concepts from the user input (e.g., prompt), optionally identify known concepts (e.g., match extracted concepts from object types in the object library), provide scene context (e.g., object instance locations within the scene, inter-object relationships, etc.), generate LLM instructions, and/or perform other functionalities.

However, the interpretation agent may be otherwise configured.

The populator agent (e.g., scene composer) functions to compose the scene using instances of assets for each object instance (e.g., determined by the interpretation agent). In an example, the populator agent can procedurally generate environments by distributing assets based on parameter values determined by the interpretation agent (e.g., numerosity, density, scale, rotation, distribution type, and spatial distribution values from the knowledge graph and/or predicted from the query, relative spatial positioning from the spatial relationship database, etc.). The populator agent (e.g., scene composer) can retrieve 3D models for the object instances and place them in poses specified by the interpretation agent, the object instance parameter values, the relationship database, and/or other spatial reference. The populator agent (e.g., scene composer) can add behaviors (e.g., animations, runtime code, etc.) to the resultant object instances. The populator agent (e.g., scene composer) can optionally detect scene changes from the user and update the object library and/or vector database.

In an example, the populator agent can receive an inter-object pose change (e.g., from a user prompt, from a user interaction with a display of the 3D scene, etc.); generate a new vector embedding that represents the new inter-object relationship; and add the new vector embedding to the relationship database in association with the object type of the changed object instance.

The populator agent (e.g., scene composer) can be generalized (e.g., compose any type of scene) or specialized (e.g., for a specific environment type, such as a built environment vs. a natural environment).

However, the populator agent (e.g., scene composer) may be otherwise configured.

The scene summary agent functions to perform a continuous audit of the current 3D scene state to provide scene context for subsequent generation steps. The scene summary agent can audit and track all object instances (e.g., concepts) currently within a virtual camera's field of view, the object instances'spatial relationships, and/or other parameters of the object instances. The scene summary agent can additionally or alternatively check the runtime state of the project, the edit history of the user actions, and/or other information. The scene summary agent can collate the visible object instances'parameter values, spatial parameter values, scene parameter values (e.g., visual style, time of day, lighting, etc.), the project runtime state, the edit history, and/or other information into the scene context. The scene summary agent can be run for each virtual camera in the scene, run when a rendered frame from a virtual camera is requested, and/or at any other time.

In a first variant, the scene summary agent generates the scene context for the scene composition. In an example of the first variant, the scene context can be generated by identifying objects visible within the camera's FOV, describing the positions of each object within the FOV, describing the relative poses of each object (e.g., based on the position of the object relative to the camera, depth position, plane position, occlusions, etc.), collating the parameter values (e.g., descriptions, attributes, abilities, etc.) for each visible object instance, and/or otherwise generating the scene context.

In a second variant, the scene summary agent generates a set of model inputs for the generative model. In an example of the second variant, the scene summary agent can generate: the scene context, a geometric scene representation (e.g., 3D scene reference, 2D reference image of the 3D scene, depth map, etc.), and/or any other set of model inputs, and/or any other model inputs. The geometric scene representation can be generated from one or more points of view (e.g., from a virtual camera's point of view).

In a third variant, the scene summary agent can generate an object set representation (e.g., scene graph), a version of an object set representation (e.g., wherein the scene includes a master object set representation, and the FOV agent generates a view-specific object set representation, etc.), not generate the object set representation, and/or be otherwise related to the object set representation.

However, the scene summary agent may be otherwise configured.

The set of agents can optionally include a style agent, which functions to maintain consistent aesthetic rendering across scenes and shots based on user-defined style parameters. The style agent can perform first-cut automation on manual tasks, leveraging prescribed styles (e.g., a style of cinematography) that a human user can later refine. In a first specific example, the style agent can be a cinematic agent that can convert “medium shot” into a layman, natural language description of what a medium shot is. In a second specific example, a cinematic agent can automatically place cameras in typical cinematic poses relative to the 3D scene, generate cinematic camera paths, and/or otherwise perform any other cinematic functions. In a third specific example, the noir agent can describe the scene with noir descriptions (e.g., generate prompts with noir descriptive text). However, the style agent may be otherwise configured.

The set of agents can optionally include a prompting agent, which functions to generate a scene-specific prompt for the generative model. The prompting agent can analyze the scene context and a 2D reference image of the scene (e.g., sampled from the camera's FOV) to generate a detailed scene-specific prompt for the diffusion model. The scene-specific prompt can include semantic and conceptual information, respective spatial positions, scene parameter values (e.g., style, lighting, mood, technical qualifiers, etc.), and/or any other information. The semantic and conceptual information can include: names of all object instances (e.g., visible in from the virtual camera), descriptions for each object instance, and/or any other semantic and conceptual information. The descriptions for each object instance are preferably user-generated descriptions, but can additionally and/or alternatively be automatically generated (e.g., collated from the object type, etc.) and/or otherwise generated. The object instance descriptions are preferably appearance descriptions (e.g., describe how the object instance should be rendered), but can alternatively or additionally include behavior descriptions, attribute descriptions, object instance parameter values (e.g., from the knowledge graph, inherited from the object type, etc.), and/or any other descriptions. When a plurality of assets are grouped into a single entity (e.g., a background environment, etc.), a single description can be generated for the grouped plurality of assets. Individual assets (e.g., detached from the grouped plurality) can have their own textual entry in the scene-specific prompt, and/or be otherwise managed. The respective spatial positions (e.g., foreground/background, left/right) can be relative to the scene, relative to another object instance, and/or otherwise referenced. The scene-specific prompt can also include the 3D scene reference (e.g., the 2D reference image, a depth map, segmentation data, etc.). The scene-specific prompt can be used to provide semantic guidance to the generative model, and/or otherwise used. However, the prompting agent may be otherwise configured.

The set of agents can optionally include a verification agent, which functions to verify that the generated frame matches the input scene information and optionally trigger frame rerendering when the generated frame deviates from the input scene information by more than a threshold amount (e.g., distance).

In a first example, the verification agent verifies that the objects in the rendered frame have boundaries that substantially match the 3D scene reference (e.g., 2D reference image). In a specific example, the verification agent can segment the objects from the rendered frame and match the object segments against the geometric segments in the 2D reference image.

In a second example, the verification agent can verify that the appearances match the respective object instance descriptions. In a specific example, the verification agent can generate natural language descriptions for each object in the rendered frame, then compare the generated descriptions against the object instance's description (e.g., using cosine similarity, embedding distance, etc.).

However, the verification agent may be otherwise configured.

The set of agents can optionally include a composer agent, which functions as a unified agent that creates and refines the scene construct.

In variants, the composer agent can replace and/or include the interpretation agent, populator, scene summary agent, style agent, and/or other agents, and perform all agent functionalities. The composer agent can include a single agent (e.g., LLM agent) that accesses knowledge graph traversal, 3D scene editing, scene context construction, scene-specific prompt generation, and/or other functionalities as different tools (e.g., instead of different agents). Alternatively, the composer agent can be otherwise constructed. The composer agent can iteratively create and refine the scene construct, create the scene construct in a single shot, and/or otherwise create the scene construct. The composer agent can operate in a loop to process prompts, check the knowledge graph, iteratively refine the scene, and/or perform any other functionalities. However, the composer agent may be otherwise configured.

However, the set of agents may be otherwise configured.

The generative model functions to generate high-fidelity visual content (e.g., frames, video, audio-video, scene renderings, etc.). The generative model can additionally generate the renderings based on visual themes (e.g., “noir”, “western”, etc.), and/or other user preferences, wherein the user preferences are converted into text and provided to the model as additional context. The generative model is preferably a diffusion model, but can alternatively be an LLM, VLM, or other generative model, a ray tracing model, a volume rendering model, a game engine, and/or any other suitable model.

The generative model can use the scene context to render pixels that adhere to the scene parameter values, the object instance parameter values, and the structural constraints provided by the scene construct. The generative model can be provided by a model provider (e.g., Stable Diffusion, MidJourney, Runway, Sora, etc.). The generative model can render an image, video, audio, and/or any other media. The generative model can render all or portions of a frame (e.g., from the FOV of the virtual camera).

The generative model preferably generates the scene rendering based on a 3D scene reference, the scene specific prompt, and/or any other input.

The 3D scene reference (e.g., geometric scene representation) is preferably a 2D reference image (e.g., sampled from the camera's point of view), but can additionally or alternatively be a depth map, segmentation map, set of masks, and/or other geometric representation of the 3D scene. The 3D scene reference preferably does not depict appearances for object instances, but can additionally or alternatively include colored segments (e.g., without appearance details), generic appearances for assets (e.g., default appearance for the asset), and/or any other appearance details. Examples of appearance details can include colors, gradients, textures (e.g., skin pores, fabric details, hair, wrinkles, leaves, branches, etc.), high-frequency components (e.g., with high Laplacian variance, high-frequency energy when transformed using a Fourier transform), components with high Canny edge density, components with high entropy (e.g., finer details, high Shannon entropy), components with fine appearance features (e.g., high CNN feature variance, etc.), and/or be otherwise defined.

However, the generative model can additionally or alternatively generate the scene rendering based on: the 3D model (e.g., the 3D model of the scene, a projection of the 3D model into a virtual camera plane, etc.), the scene context, the parameter value set for each object instance, a depth map (e.g., sampled from the camera's point of view), a segmentation map (e.g., generated from the boundaries of each visible asset), and/or other model inputs.

In an example, a 2D projection of the 3D scene, depicting the object boundaries and poses, is passed along with the parameter value set for all object instances within the scene (e.g., visible and/or not visible) to a generative model, wherein the generative model predicts the visual appearance of the frame (e.g., for the entire 2D projection, for individual object instances, etc.).

The resultant rendered frame is preferably aligned (e.g., pixel-aligned) with the input geometric model information (e.g., with the 2D projection), but can additionally and/or alternatively be otherwise aligned. Since the frame can be pixel-aligned with the 2D projection, and since the 2D projection can be directly associated with the 3D model, pixels associated with different object instances within the frame can be inherently segmented out. This can enable the object instance to be selected in the frame, dynamically rerendered, and/or otherwise manipulated.

In an example, the object instance in the frame can be rerendered by requesting a new appearance prediction for an updated object instance, removing the frame pixels associated with the object instance's 2D projection, replacing the old frame pixels overlapping the object instance's 2D projection with the new appearance prediction, and optionally infilling and/or predicting a new appearance for frame pixels vacated by the object instance.

The generative model can optionally be used with a set of conditional control modules. The set of conditional control modules can function to enforce adherence to the structure and geometry of the 3D scene. Alternatively, the generative model can be used without conditional control modules, wherein the generative model inherently or iteratively verifies that the objects in the rendered frame substantially match the object pixels in the 3D scene reference (e.g., 2D reference image). Examples of conditional control modules that can be used can include conditioning networks, conditional diffusion architectures (e.g., ControlNets, T2I-adapters, IP-adapters, tuned adapters, joint encoders, etc.), U-nets (e.g., a separate UNet from the generative model, a clone of the generative model's UNet, a clone of the generative model's UNet with additional input channels and zero convolution layers, etc.), and/or any other conditional control modules. The conditional control module can receive a representation of the 3D scene (e.g., 2D reference image, segmentation map, depth map, normal map, etc.), the rendered frame, optionally the scene context, and/or other information.

In a first variant, the conditional control modules can encode the 3D scene representation and the rendered frame (or segments thereof) into a latent space and compare the resultant embedding vectors (e.g., wherein the rendered frame is considered consistent with the 3D scene representation when the embeddings match within a threshold similarity or distance).

In a second variant, the conditional control modules can transform the structured 3D scene representation into a set of feature-space constraints that modulate the layers of the generative model (e.g., by injecting feature blocks into the generative model, such as by using residual addition).

However, the generative model may be otherwise configured.

### 4. Method

As shown in FIG. 1, variants of the method can include: receiving a query from a user S100; generating a scene construct based on the query S200; generating a model input from the scene construct S300; prompting a generative model using the model input to generate visual content S400; optionally displaying the visual content to the user S500; optionally receiving a scene construct edit S600; optionally automatically updating the visual content based on the scene construct edit S700; and optionally generating timeseries visual assets based on the visual content S800. The method functions to accurately and repeatably generate visual assets using generative models.

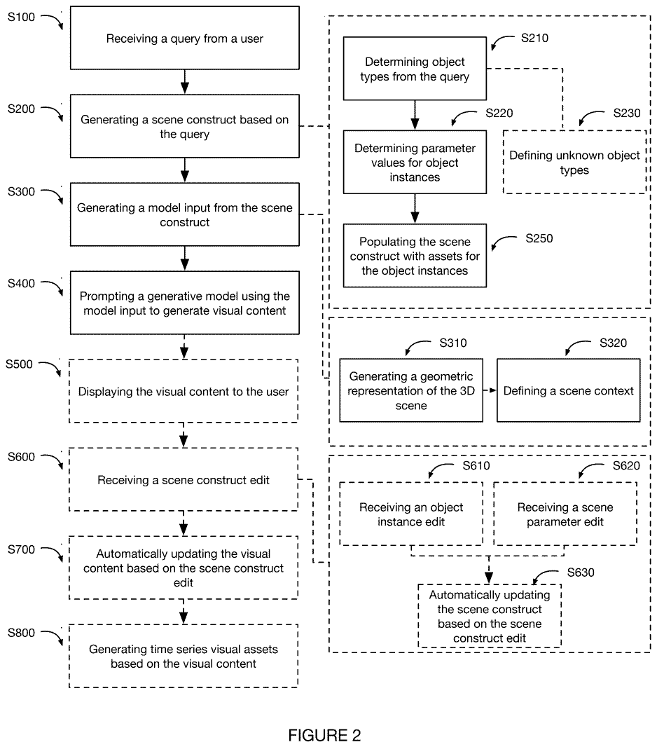

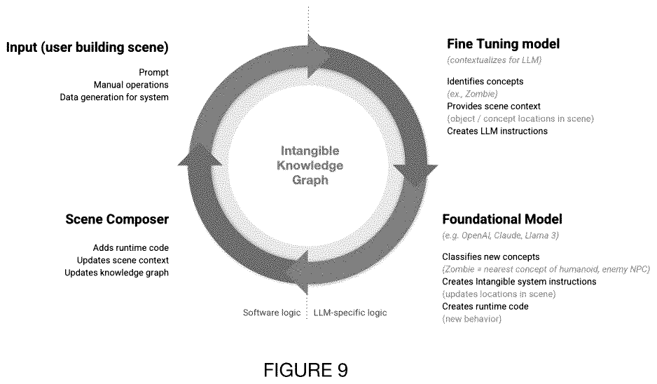

The method can enable utilization of generative models for rendering while controlling generative model hallucinations. In examples, the method can control generative model hallucinations by constraining the geometry and mechanics of the scene (e.g., using the 3D scene representation) and by constraining the object appearance using the parameter value set. Examples of the method are shown in FIG. 1, FIG. 2, FIG. 3, FIG. 4, and FIG. 9.

The visual assets that can be generated using the method can include: a single frame, a set of frames (e.g., set of keyframes, series of frames, etc.), and/or other visual assets. The method is preferably performed using the system described above, but can alternatively be performed using any other suitable system. The method can be performed on the cloud (e.g., through a browser-based interface), locally, and/or any other suitable manner.

All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

Receiving a query from a user S100 functions to receive a description for the scene from the user.

The query can include: a text description, audio description, visual description (e.g., example frame, video, etc.), programmatic request (e.g., API call, etc.), a set of user selections (e.g., of object types, object parameter values, etc.), a set of user actions, an appearance reference (e.g., appearance image, LoRA, etc.), and/or have any other suitable form or modality. S100 can be repeated one or more times (e.g., to set up the scene, edit the scene, regenerate the rendering, etc.). The query can be received at a user interface (e.g., graphical user interface), an API, and/or any other interface. The query can be for the scene as a whole, an individual asset of the scene, and/or any other query. The query (e.g., prompt, etc.) can be a new query for the scene (e.g., scene prompt; initial query for the scene), a subsequent query for the scene (e.g., modifying the scene generated using prior queries), object instance-specific query modifying parameter values of the object instance (e.g., object instance prompt), and/or any other query. Illustrative examples of queries that can be received can include: “generate a tropical forest”, “add three zombies next to the crates”, and/or any other queries.

However, receiving a query from a user S100 may be otherwise performed.

Generating a scene construct based on the query S200 functions to generate the 3D scene representation and the parameter values for each object instance in the scene. S200 can be performed: once, iteratively (e.g., based on successive queries, based on automated scene verification, etc.), and/or any other number of times.

In variants, generating a scene construct based on the query S200 includes determining object types from the query S210; determining parameter values for object instances S220; optionally defining unknown object types S230; populating the scene construct with assets for the object instances S250; and associating object instance parameter values with the respective asset S260. However, S200 can be otherwise performed.

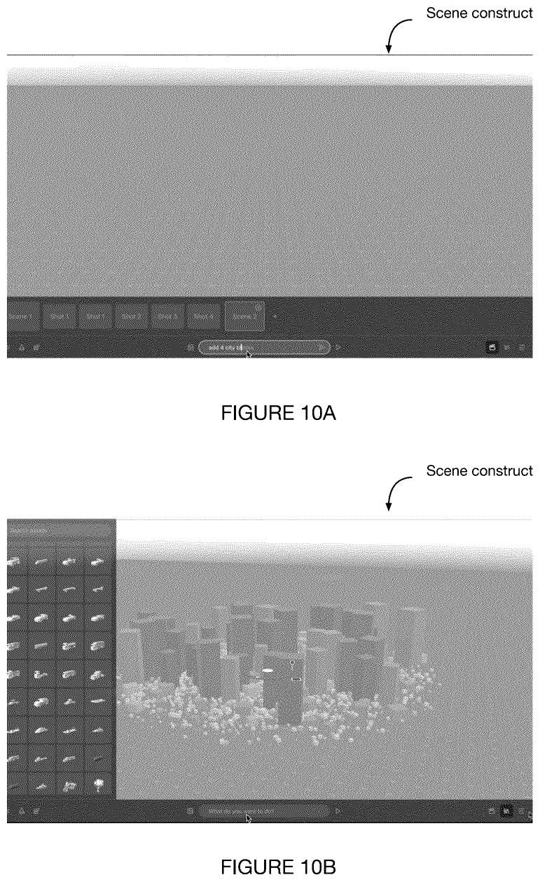

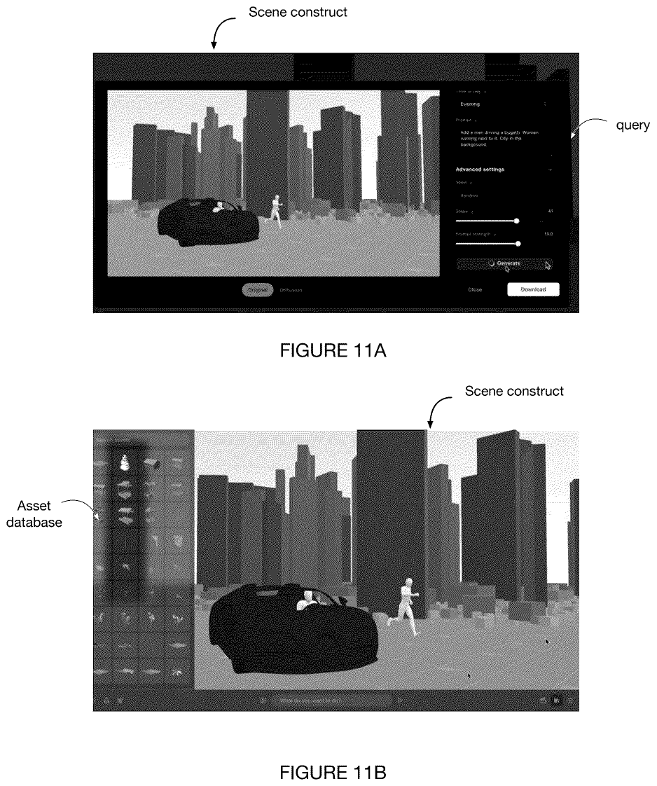

Determining object types from the query S210 functions to identify the object types explicitly and implicitly mentioned by the query. Examples of S210 are shown in FIG. 2, FIG. 3, FIG. 4, FIGS. 10A-10B, FIGS. 11A-11B. Object types can be identified using an entity extractor, part-of-speech classifier (e.g., extracting the nouns, verbs, adverbs, etc.), large model (e.g., by querying the LLM to return object types mentioned or related to the query), classifier, neural network (e.g., DNN, CNN, RNN, etc.), and/or any other model.

In a first variant, S210 can include identifying object types explicitly mentioned in the query.

In a second variant, S210 can include querying an LLM to return object types associated with the query. In a first example of the second variant, S210 can include querying the LLM to return object types from the query or related to the query. In a second example of the second variant, S210 can include querying the LLM to return secondary object types associated with the already-identified object types (e.g., “what objects are associated with forests”, “what other objects are found in a forest with trees”, etc.). The queries can be automatically generated (e.g., programmatically, according to a set of rules, etc.), generated by an LLM, and/or otherwise generated.

In a third variant, S210 can include identifying secondary object types by traversing the object library. In a first example of the third variant, secondary object types can be identified by identifying object types connected to already-identified object types from the object library (e.g., by traversing the knowledge graph and identifying child object types or related object types, by traversing the relationship database and identifying co-occurring object types, etc.). In a specific example, secondary object types can be identified by identifying secondary object types embedded within a threshold vector distance from the already-identified object types in the relationship database.

In an illustrative example, object type identification can include extracting “forest” and “deer” from a user query including “deer grazing in the forest”.

The object types are preferably extracted from the query by the interpretation agent, but can additionally or alternatively be performed by the composer agent and/or by any other set of agents.

S210 can be iteratively repeated until a stop condition is met. In examples, stop conditions can include: identifying object types at least a threshold number of degrees out from the explicitly-mentioned object type; no additional object types are identified; and/or any other stop conditions.

S210 can be performed independent of the set of known object types (e.g., independent of the knowledge graph, without knowledge of the object types in the knowledge graph, etc.), but alternatively determined based on the set of known object types (e.g., based on the knowledge graph, by referencing the knowledge graph, etc.).

In a first example, the object types are predicted from the query independent of the knowledge graph, wherein known and unknown object types are subsequently identified by comparing the set of predicted object types to the set of known object types represented in the knowledge graph. The known object types can be determined using: a direct match, a semantic match (e.g., using a similarity score between the known object's semantic embedding and the query object's semantic embedding, etc.), querying an LLM to return the closest object type from the object library to the identified object type, and/or otherwise determined.

In a second example, the known object types associated with the query are identified by traversing the knowledge graph (e.g., by comparing the query to the object types in the knowledge graph, by identifying known object types within the knowledge graph with a threshold similarity to entities mentioned in the query, etc.).

In a third example, one or more child object types associated with the identified object type in the object library (e.g., knowledge graph, relationship database, etc.) can also be retrieved. In a first specific example, only a subset of the child object types associated with the identified object type in the knowledge graph are retrieved (e.g., the child object types associated with the query with more than a threshold similarity) In a second specific example, all child object types associated with the identified object type in the knowledge graph are retrieved. In a third specific example, all or a subset of the object types located within a predetermined vector distance of the identified object type in the relationship database (e.g., the latent space) are retrieved.

However, the object types associated with the query can be otherwise determined based on the knowledge graph.

S210 can optionally include determining layout information for the extracted object types. The layout information can include: the number of instances of each object type, the density within the scene, scale factors, the pose within the scene, the pose and/or interaction with other object instances, the pose of the object instance's asset's skeleton, rotation factors, randomization factors, distribution pattern, and/or any other set of layout information. The layout information is preferably determined in the same manner as parameter value determination, but can alternatively be otherwise determined.

In a first variant, the layout information can be retrieved from the knowledge graph based on ontological parameter values associated with a parent object type that was identified in the query (e.g., in S210).

In a second variant, the layout information can be predicted by an LLM from the query (e.g., “add three zombies next to the crate” can determine that 3 instances of the “zombie” object type need to be added to the scene, next to the virtual space associated with the “crate” object instance).

In a third variant, the layout information can be specified by a user.

The layout information can be used to determine how many of each object type (e.g., number of object instances) to populate into the scene, where and how to position each object, and/or be otherwise used. The layout information values can be merged into the parameter values for the respective object instance, be included in the scene context, be discarded after initial scene population, and/or otherwise used.

However, determining object types from the query S210 may be otherwise performed.

Determining parameter values for object instances S220 functions to customize the instances of the object types (“object instances”) based on the user queries. Examples of S220 are shown in FIG. 2, FIG. 3, and FIG. 4. The parameter values (e.g., attributes, abilities, relationships, etc.) for the object instances can be predicted by a model (e.g., based on the query), retrieved from the object library (e.g., retrieved from the knowledge graph and/or the relationship database based on the identified object type, etc.), looked up from a third party source, received from the user (e.g., as an explicit parameter value selection, as a textual description entry, etc.), and/or otherwise determined. The parameter values can be predicted by the same model determining the object types, or by a different model. In an example, the user can specify a description for an object instance in a query (e.g., “the elf has a purple robe and a floppy hat”). In this example, the query can be for the scene as a whole, for the overall project, for the object instance itself (e.g., wherein the user selects the respective asset, example shown in FIG. 11B; describes, or otherwise identifies the object instance in the scene; etc.), and/or for any other set of object instances in the scene.

The parameter values are preferably determined based on a query, but can additionally or alternatively be determined based on the object type (e.g., inherited from the object type, selected from a set of available candidate parameter values for the object type, etc.), specified by a user in an object instance description (e.g., text description), and/or otherwise determined. The parameter values can be determined in the same pass as the object types, in a subsequent pass, and/or with any other relationship to the object types.

Examples of parameter values that can be determined can include: abilities, attributes, semantic relationships, spatial relationships (e.g., pose relative to the scene, relative to other object instances, etc.), scale, animations (e.g., from the set of animations associated with the object type), descriptions (e.g., interactions, backstory, personality, interactions with other objects, appearance, etc.), and/or any other parameter values.

In a first variant, S220 can include retrieving default parameter values for the object type from the object library.

In a second variant, S220 can include querying an LLM to return values for the parameters of each object type (e.g., wherein the parameters and candidate values can be provided to the LLM in addition to the query). In examples, this can include instructing an LLM to provide a description of each object type, instructing an LLM to return a pose for the object based on the user query, and/or otherwise instructing the LLM.

In a third variant, S220 can include selecting parameter values using a rule set.

In a fourth variant, S220 can include receiving parameter values from the user. In an example, the user can enter or select parameter values for the object instance; the user can specify the object pose by dragging, dropping, and/or rotating the 3D model associated with the object type; and/or otherwise enter the parameter values.

However, determining parameter values for object instances S220 may be otherwise performed.

Generating a scene construct based on the query S200 can optionally include defining unknown object types S230, which functions to specify new object types that were not already included in the object library. The new object can optionally be added to the object library (e.g., added as an object subtype with the new parameter values, added as a sister class with the new parameter values, etc.). Examples of S230 are shown in FIG. 2 and FIG. 3. S230 can be performed by an object type generator and/or other module. The object type generator can be an LLM, VLM, the interpretation agent, and/or any other model.

S230 can include determining that object type is not included in the object library, identifying the most similar known object type to the unknown object type, determining new parameter values for the unknown object type, and/or optionally adding the new object type to the knowledge graph.

In an example, determining that object type is not included in the object library includes determining that no known object type matches beyond a threshold similarity.

Identifying the most similar known object type to the unknown object type can include using the object types and/or ontology from the object library (e.g., wherein object types and/or parameters thereof are also passed to the LLM). In a first variant, identifying the most similar known object type can include using a similarity score between an embedding for known object types and the unknown object type. In an example, the embeddings that can be embeddings of the object type name, descriptions of the object type, parameter values of the object type, and/or of other object parameters. In a second variant, identifying the most similar known object type can include querying a LLM to return a set of known object types closest to the unknown object type. In a third variant, identifying the most similar known object type can include receiving a known object type selection from a user.

In a first variant, determining new parameter values for the unknown object type can include: determining a name for the object subtype, determining candidate abilities, attributes, and relationships for the object type, generating a new 3D model for the object subtype, and/or determining any other set of parameter values for the unknown project type. The new object type can inherit all or a subset of parameter values from the known object type, and overwrite all or a subset of the parameters with new parameter values.

In a second variant, determining new parameter values can include querying a model (e.g., LLM) to select the set of parameter values for the unknown object type from a set of candidate values for each parameter of the object type.

In a third variant, determining new parameter values can include instructing an LLM to generate values for parameters of the object type.

In a fourth variant, determining new parameter values can include merging parameter values from the similar known object types.

In a fifth variant, determining new parameter values can include receiving the new parameter values from the user.

However, the new parameter values can be otherwise determined.

The new object type to the knowledge graph can be added as a sister object type to the similar existing object type, as a child object type of the similar existing object type, and/or otherwise added. For example, an unknown “zombie” object type can be associated with a known “humanoid” object type, an “enemy NPC” attribute selected from a predetermined set of attribute options, and a newly-generated “enemy patrol & attack” behavior.

However, defining unknown object types S230 may be otherwise performed.

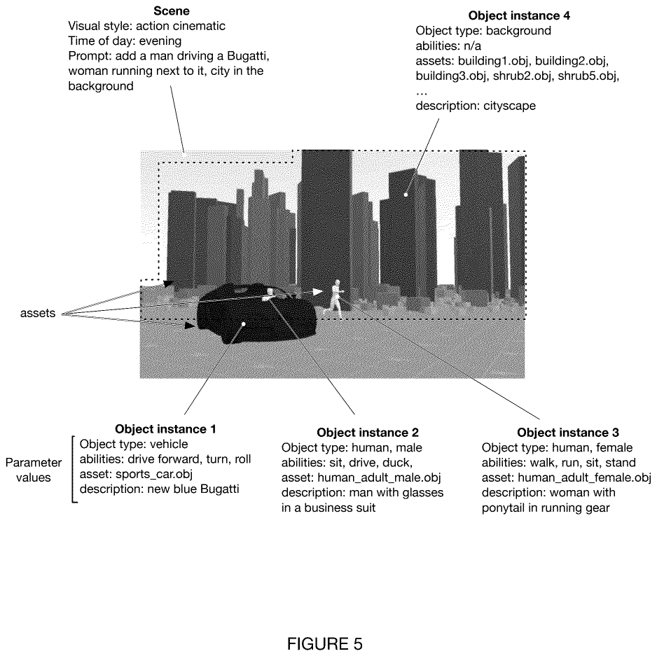

Populating the scene construct with assets for the object instances S250 functions to populate the 3D scene with 3D models representative of the object instances. Examples of S250 are shown in FIG. 2, FIG. 3, FIG. 4, and FIG. 5. The assets (e.g., 3D models) in the scene construct can be associated with the object instances, the respective parameter values (e.g., attributes, abilities, descriptions, etc.), and/or other object instance information. S250 can be performed by the populator agent, the composer agent, and/or by any other module. In an illustrative example, S250 can populate a 3D scene with 3D models (assets) for a forest (e.g., trees, bushes, grasses, flora, fauna, etc.).

Populating the scene construct with assets for the object instances S250 can include: retrieving the asset, determining layout information for the object instance, adding the asset to the virtual scene, and/or any other process.

Retrieving the asset (e.g., 3D model) preferably includes retrieving the asset identified by the asset identifier stored by the object type, but can alternatively include retrieving a user-specified asset, and/or otherwise determining the asset. In variants, the system can fetch different asset variants or configurations for the same object type (e.g., randomly select between the top 5 palm trees) to introduce variation and/or ensure the scene is not static. Alternatively, the system can fetch the same asset variant for a given object type.

The determined layout information can include: spatial relationships, density, scale factors, rotation random factors, distribution type (e.g., grid, spiral, random, etc.), and/or any other layout information. The spatial relationships can be relative to the scene, relative to another object, and/or any other spatial relationship. The layout information can be randomly determined, determined using a set of probabilities (e.g., defined in the relationship database), predicted (e.g., based on the query), specified by the object type's parameter values, specified by the relationship database, and/or otherwise determined.

In a first example, adding the asset (e.g., 3D model) to the virtual scene can include adding the asset to the scene in a location for the object instance that is predicted by an LLM based on the query. In a second example, adding the asset (e.g., 3D model) to the virtual scene can include adding the asset to the scene in a predetermined pose adjacent a secondary reference asset wherein the predetermined pose is specified by the relationship database (e.g., a couch is added to the same plane 3 ft from a coffee table). In a third example, adding the asset to the virtual scene can include adding the 3D model to the scene with the pose specified by the pose parameter, scaling and rotating the assets based on the parameter values, and/or otherwise posing the asset. The 3D model (and/or voxels that the 3D model occupies) is preferably associated with the object instance and respective parameter values, but can alternatively be associated with other information.

S250 can optionally include grouping a set of assets together into a single entity. In examples, a set of object instances (e.g., the respective asset instances, the parameter values, etc.) can be unified into a higher-order asset (e.g., a single entity, a “background asset”). This can reduce the context length required to fully describe the scene, which can satisfy the context length limitations imposed by the generative model, improve the generative model's attention to individual object instances, and/or otherwise improve the general model's utilization and/or functioning. Alternatively, all object instances can be treated individually. The set of object instances can be unified based on: a shared parent object type in the knowledge graph; a specific type of ontological or semantic relationship in the knowledge graph (e.g., “contains”); scene layer (e.g., background, foreground, midground, etc.); based on how the respective object instances were identified (e.g., wherein object instances associated with child object types identified based on a parent object type are default grouped together); utilization as a unitary object (e.g., when the user treats the set of object instances as a single object); manual selection (e.g., wherein the user selects and groups the set of object instances); and/or otherwise determined.

Individual object instances can be separated from the grouped set upon user manipulation of the object instance (e.g., manipulation of the respective asset). Examples of user manipulation can include: selecting the object instance, editing the description of the object instance independently of the group, and/or other manipulations.

In an illustrative example, the system can receive a user request to generate a complete environment (e.g., “generate a tropical forest”), wherein the system: queries the knowledge graph for the environment concept (e.g., “tropical forest”); defines the environment through ontological relationships (e.g., tropical forest contains palm trees, banana trees, bushes, shrubs, flowering plants, marsh grass, and other sub-concepts as related concepts) and the respective ontological parameter values associated with the identified object types (e.g., density, scale, rotation, distribution of the sub-concepts); retrieves assets for each instance of each identified object type; places the assets in the scene according to the ontological parameter values (and optionally the physical relationships extracted from the relationship database); and groups all the asset instances into a single entity (e.g., until the user explicitly isolates individual parts). The single entity can be named with a single identifier (e.g., “tropical forest”) for the purposes of passing parameter values (e.g., metadata) to the generative model (e.g., in a prompt). The parameter values for the single entity can be that of the parent object type, an aggregation of the child object type parameter values (e.g., average, mean, distribution, etc.), concatenation, and/or otherwise determined. Individual object instances in the single entity (e.g., sub-assets) are preferably not individually named or described in the prompt, but can alternatively be individually named or described. Individual object instances can optionally be detached from the single entity (e.g., by selecting the object instance, etc.), wherein the individual object instance can be treated as a separate asset from the single entity post detachment (e.g., individually named, individually described, individually placed, associated with its own prompt entry in the rendering prompt, etc.).

When additional object instances are added to the scene, the single entity can be edited or regenerated to suppress or otherwise manage object density in that specific area to create a clear path or opening (e.g., suppress tree population where a road is placed, etc.), or otherwise managed.

S250 can optionally include establishing registrations between assets (e.g., such that the assets move together). Establishing registrations between assets can create implicit parent-child relationships, cooccurrence relationships, and/or any other relationships.

In a first variant, establishing registrations between assets can automatically register a first object instance with a predefined region of a second object instance based on registration rules specified by the respective object types (e.g., the human object type specifies that the humanoid asset sits on the seat of a chair asset when within a predetermined distance of the seat).

In a second variant, establishing registrations between assets can include registering the first object instance with a predefined region of a second object instance based on a user entry. In a first example of the second variant, the user drags and hovers the first object instance within a predetermined distance of the region of the second object, wherein the first object is automatically registered to the region of the second object. In a second example of the second variant, the user describes (e.g., using natural language) the desired registration (e.g., “the driver sits in the car” can automatically register a human asset with the driver's seat of a car asset).

S250 can optionally include adding virtual cameras to the 3D scene. The virtual cameras can be randomly placed, specified by a user (e.g., using a manual camera placement; using a text description of where the camera should be placed; etc.), using a reference field of view of a reference camera, based on a scene description (e.g., based on the shooting style of the scene), and/or otherwise configured.

However, populating the scene construct with assets for the object instances S250 may be otherwise performed.

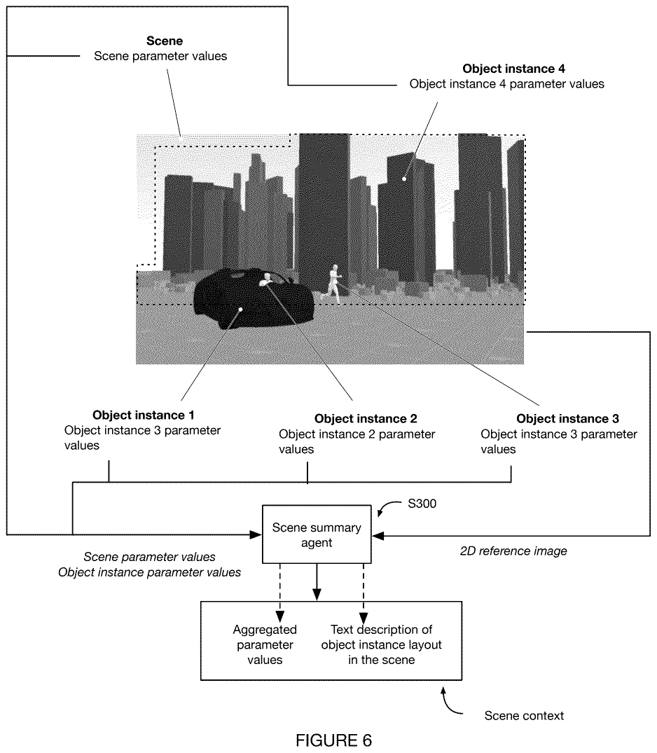

Associating object instance parameter values with the respective asset S260 functions to link the object instance data to regions of the 3D scene. This can include associating the object instance descriptions, conditional logic, selected animations, and/or other information to the asset (and/or voxels occupied by the respective asset). Examples of S260 are shown in FIG. 2, FIG. 5, and FIG. 6.

The object instance parameter values can be associated with the respective asset by the object instance name (e.g., unique identifier), by the voxels themselves, and/or otherwise linked. In a specific example, S260 can include associating identified behaviors with the asset (e.g., wherein the identified behavior can reference a predetermined animation for the asset). In an illustrative example, asking for a “Zombie” automatically assigns it default behavior like patrol and attack, wherein the humanoid asset associated with the “zombie” instance is associated with patrol and attack animations. However, associating object instance parameter values with the respective asset S260 may be otherwise performed.

However, generating a scene construct based on the query S200 may be otherwise performed.

Generating a model input from the scene construct S300 functions to generate a generative model-compatible input. The model input can represent a portion of the scene (e.g., be a 2D projection of the scene) or the entire scene. The model input can include: a geometric representation of the object instances in the scene (e.g., 3D scene representation), scene context, and/or any other suitable input. Examples of S300 are shown in FIG. 2, FIG. 3, FIG. 4, and FIG. 6.

In variants, generating a model input from the scene construct S300 can include: generating a geometric representation of the 3D scene S310; defining a scene context S320; and/or generating any other model input component.

Generating a geometric representation of the 3D scene functions to generate a geometric reference for the generative model. The geometric representation can include: 2D frame (e.g., projection of the scene construct onto the virtual camera's plane), a 3D representation (e.g., hull, mesh, point cloud, depth map), segmentation map, set of masks (e.g., for each object instance, for a plurality of object instances, etc.), set of occlusions, set of rays, and/or any other representation of the scene geometry. The model input can include one or more geometric representations of the 3D scene. The different geometric representations can be from different perspectives, different fields of view, different timesteps (e.g., after an animation has been played for a predetermined period of time), and/or otherwise differ. The geometric representation can be determined by determining a 2D projection of a portion of the scene onto a viewing plane of a virtual camera, taking a snapshot of the scene from the camera, and/or otherwise determined. The viewing plane can have the perspective and/or FOV of: a virtual camera placed within the scene; the user's perspective of the scene (e.g., the view of the scene from a user interface's point of view); and/or be otherwise defined. However, generating a geometric representation of the 3D scene S310 may be otherwise performed.

Defining a scene context S320 functions to define parameter values for the scene. Examples of scene parameters can include: the visual style (e.g., “noir”, “anime”, etc.), how closely the generative model should adhere to the 3D models of the object instances, camera context, edit history, runtime state, time of day, visual style, technical resolution, names for all or a subset of the object instances in the scene, descriptions for all or a subset of object instances in the scene (e.g., for all object instances in the scene, for visible object instances in a virtual camera's frustum, etc.), parameter values for all or a subset of the object instances in the scene (e.g., for all object instances, only visible object instances, etc.), selected animations for each asset, and/or other scene parameters. The scene context can be a text description (e.g., in natural language), set of quantitative values, and/or in any other modality. The scene context preferably includes a freetext description, but can alternatively include a structured description. The scene context can be received from a user, inherited from another scene, and/or otherwise determined. However, defining a scene context S320 may be otherwise performed.

However, generating a model input from the scene construct S300 may be otherwise performed.

Prompting a generative model using the model input to generate visual content S400 functions to generate high-fidelity visual content corresponding to the scene construct. S400 can be performed in real-or near-real time (e.g., as the object instance descriptions, object instance parameter values, scene parameter values, and/or other information are determined), in response to a generation request, and/or at any other time. Examples of S400 are shown in FIG. 2, FIG. 3, and FIG. 4. The generative model is preferably a diffusion model or GAN, but can additionally or alternatively be a rendering model, gaming engine, and/or any other model. The generative model can additionally include a set of conditional control modules to enforce generative model rendering adherence to the reference geometry (e.g., the 3D scene reference, the 2D reference image, etc.). The resultant visual content preferably includes an appearance, but can alternatively have no appearance (e.g., only include geometry). The visual asset can be photorealistic, true to the scene parameter values (e.g., visual style), and/or have any other style. Image segments corresponding to the object instance can be rendered with an appearance consistent with the object instance's description and/or parameter values, but can alternatively be otherwise rendered. The visual content can be: a 3D environment (e.g., static or dynamic; interactive or noninteractive; etc.), a 2D frame, an image, a video, audio-video content, and/or in any other modality. Each pixel in the visual content can be mapped to an object instance in the scene construct.

In a first variant, the visual content is preferably aligned (e.g., pixel-aligned) with the scene construct (e.g., appearance-containing visual representations of each object instance is aligned with the respective object instance within the scene construct), but can alternatively be misaligned, overlapping, spill over, underfill, and/or otherwise aligned with the object instance's asset in the scene construct.

In a second variant, the generative model can attach an object instance identifier to each pixel generated from the object instance.

The visual content can also be generated using a set of model hyperparameters. The model hyperparameters can include: the seed (e.g., random, seed value, etc.), the number of generation steps, the prompt strength, guidance scale, sampling algorithm, denoising strengths, starting/ending sigmas, batch size, VAE choice, output resolution, latent resolution, embedding method, ControlNet weights, conditioning scale, temperature, reference image weight, cross attention control, and/or other hyperparameters. The model hyperparameter values can be received from a user, be default values, be determined based on the query (e.g., by the LLM), and/or otherwise determined.

However, prompting a generative model using the model input to generate visual content S400 may be otherwise performed.

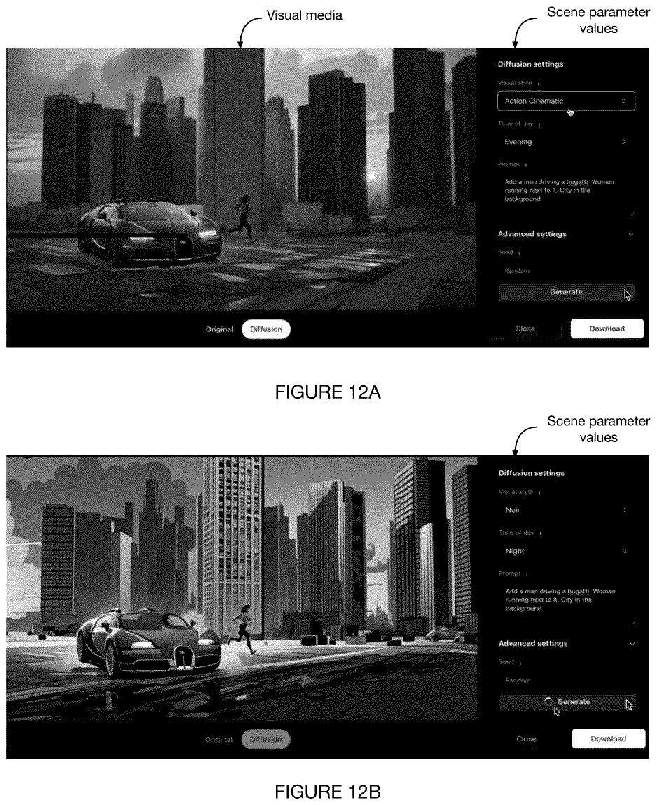

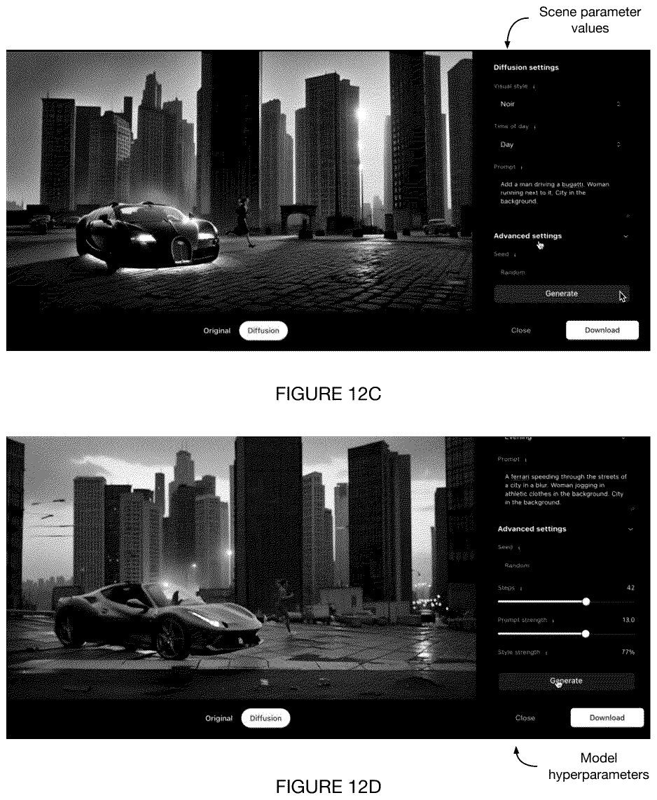

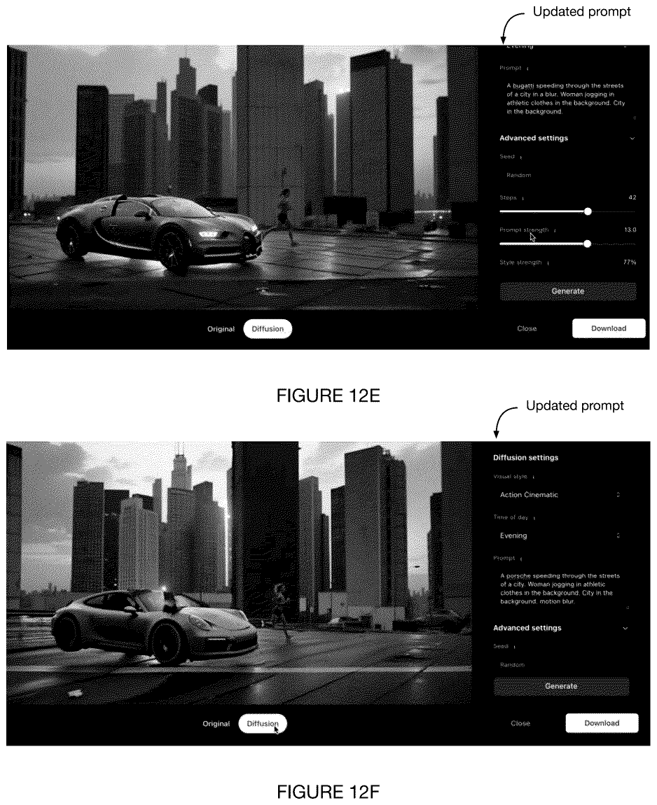

The method can optionally include displaying the visual content to the user S500, which functions to present the visual content to the user. Examples of S500 are shown in FIGS. 12A-12F. S500 can enable the user to use the visual content, edit the visual content (e.g., the underlying scene construct), and/or otherwise interact with the visual content. The visual content can be displayed on a user interface, played the visual content on a media player, and/or otherwise displayed. The visual content can be displayed in real-or near-real time (e.g., with content generation), asynchronously, and/or at any other time. However, displaying the visual content to the user S500 may be otherwise performed.

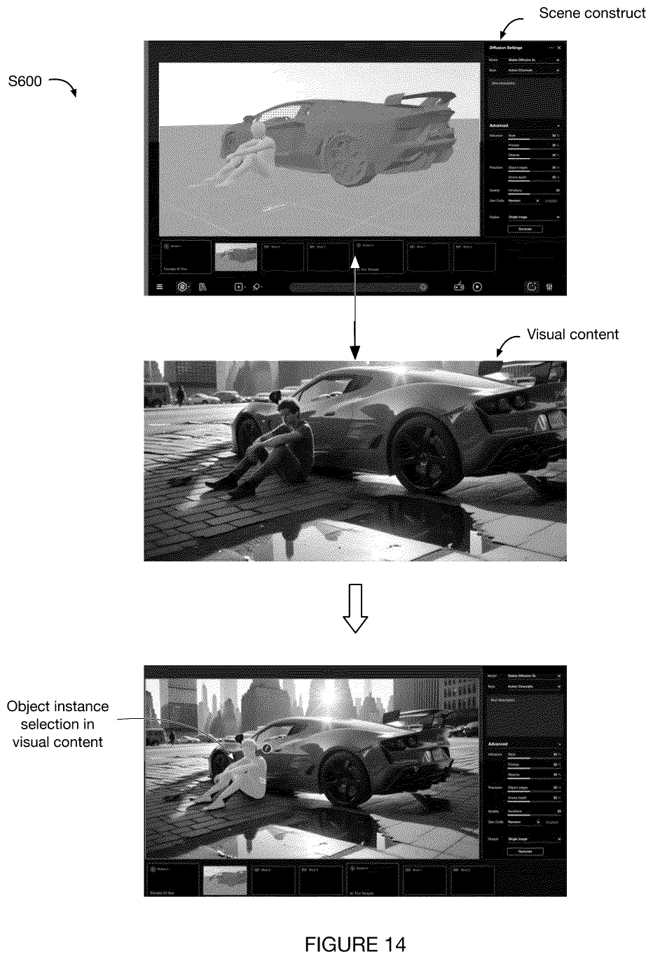

The method can optionally include receiving a scene construct edit S600, which functions to iteratively update the scene. The scene construct edit can be received from a user, automatically determined by an LLM, and/or otherwise determined. Examples of S500 are shown in FIG. 14, FIG. 12E, and FIG. 12F.

In variants, receiving a scene construct edit S600 optionally includes receiving an object instance edit S610; optionally receiving a scene parameter edit S620; and optionally automatically updating the scene construct based on the scene construct edit S630.

Receiving an object instance edit S610 functions to edit the asset and/or parameter values of the object instance. In variants, receiving an object instance edit S610 can include: receiving an object instance selection from the user; and/or receiving an edit to the object instance. Receiving an object instance selection from the user functions to identify a set of pixels within the visual content to replace and/or identifying an asset in the 3D scene to replace. The object instance can be selected by selecting pixels associated with the object instance, verbally identifying the object instance, by selecting the asset in the 3D scene for the object instance, and/or otherwise identifying the object instance.

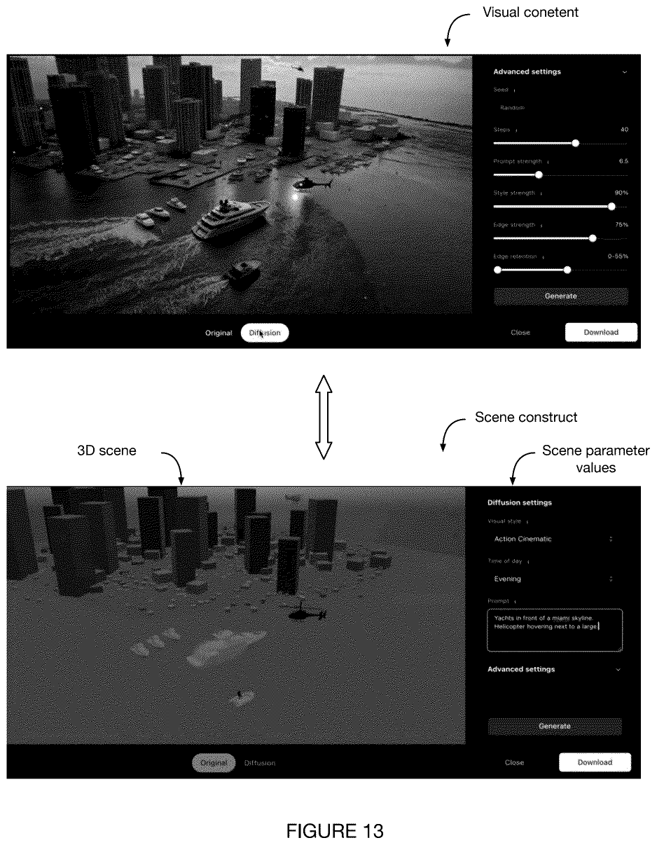

In a first variant, the appearance-rendered frame can be pixel aligned to a 3D model of the object instance, wherein the selected pixel position can be mapped to the asset for the object instance, which can be mapped to the underlying parameter value (e.g., object description). Examples are shown in FIG. 13 and FIG. 14. In an example of the first variant, a user selects a set of pixels aligned with the object's 3D model in the visual content, wherein the set of pixels in the visual content that are aligned with the 3D model can be identified, highlighted, selected, and/or otherwise processed.

In a second variant, each pixel can be associated with a scene construct voxel (on the scene construct coordinate system), wherein a pixel position selection maps to a voxel, wherein the object instance associated with the voxel can be selected (and/or the asset selected with the majority of voxels in that region is selected).

In a third variant, objects in the visual content can be semantically segmented, wherein each segment can be associated with the highest-overlapping asset in the scene.

In a fourth variant, each object instance in the scene construct can be given a unique ID that is sent to the generative model (ex. “car with carID with scale1 and pose2 that is a Ferrari”), wherein each pixel in the returned frame is labeled with the UID. The selected object instance can be identified by the UID of the pixel.

In a fifth variant, the object instance can be selected by flat shading the 3D object model with selected pixels from the frame (e.g., intersecting with a projection of the asset onto the frame).

However, receiving an object instance selection from the user may be otherwise performed.

Receiving an object instance edit S610 can optionally include receiving an edit to the object instance, which functions to dynamically edit the scene construct (e.g., in real-or near-real time). The edit can be received through a user interaction (e.g., moving the asset, through a text input, through a selection, etc.), randomly generating the new values, requesting an LLM to generate new parameter values, and/or otherwise received. The examples of object instance edits that can be received can include new parameter values (e.g., new descriptions, new poses, character motion through gameplay, etc.), object instance removal, 3D model replacement (e.g., asset replacement; replacement with a new mesh, replacement of a mesh with a skeleton, etc.), object instance addition, and/or any other object instance edit.

In a first example, the user can select, drag, and drop the asset in a different position, wherein the position values associated with the object instance are updated with the new position.

In a second example, the user can drag a new object instance into the scene construct (e.g., from the library of assets) and specify parameter values for the new object instance.

In a third example, the change can be an object type change, wherein the old object instance is replaced with the new object's 3D model (e.g., asset) and the old object instance's parameter values are replaced with the new object's parameter values.

In a fourth example, the user can enter a new description for the object instance (e.g., backstory, personality, etc.), wherein the new description can overwrite or be appended to the description in the parameter value set.

In a fifth example, the user can enter a new prompt (e.g., “add a wizard to the right of the elf”), wherein S100-S500 can be repeated using the prior scene construct and object instance information extracted from the new prompt (e.g., wherein object instance information extracted from the new prompt is used to add, remove, and/or edit object instances in the prior scene construct).

However, receiving an edit to the object instance may be otherwise performed.

However, receiving an object instance edit S610 may be otherwise performed.

Receiving a scene construct edit S600 can optionally include receiving a scene parameter edit S620, which functions to change the overall rendering parameters for the scene.

In a first variant, the scene parameter edit can be received at a set of structured scene parameter input fields (e.g., changing “cinematic” style to “noir”).

In a second variant, the new scene parameter values can be automatically determined by an LLM (e.g., based on a script, a reference image, a user prompt, etc.).

However, receiving a scene parameter edit S620 may be otherwise performed.

Receiving a scene construct edit S600 can optionally include automatically updating the scene construct based on the scene construct edit S630, which functions to update the 3D scene and/or scene context based on the edit. S630 can additionally generate an updated set of model inputs based on the updated scene construct (e.g., by repeating S300 using the updated scene construct). S630 can be performed by repeating one or more of S100 to S400, but can alternatively be otherwise performed. However, automatically updating the scene construct based on the scene construct edit S630 may be otherwise performed.

However, receiving a scene construct edit S600 may be otherwise performed.

The method can optionally include automatically updating the visual content based on the scene construct edit S700, which functions to dynamically update the visual content (e.g., in real-or near-real time). S700 can rerender all or parts of the visual content. The visual content is preferably rerendered using the updated parameter values, but can additionally and/or alternatively optionally also use all or a portion of the prior parameter value set (e.g., the unchanged parameter values, the parameter values for unchanged object instances, etc.). Re-rendering can include: infilling, prompting a generative model to generate visual content for a subset of the scene (e.g., for only the selected object instance), and/or otherwise re-rendering all or portions of the visual content.

In a first variant, S700 can rerender changed portions of the frame (e.g., pixel regions associated with the changed object). In a first example, rerendering the changed portions of the frame can include passing the visual content to the generative model with the updated geometric representation of the scene and the updated parameter values for each object instance in the scene and instructing the generative model to only regenerate a predetermined set of pixels or a specific set of object instances. In a second example, rerendering can include instructing the generative model to regenerate a visual segment for the updated object instance (e.g., based on the scene context, the object's parameter values, etc.), and compositing the visual segment with the visual content; optionally determining occlusions using a projection from the virtual camera and displaying visible portions of the new object; and/or otherwise rerendering changed portions.

In a second variant, S700 can infill or rerender vacated sections of the frame (e.g., the pixels in the areas that the object was removed from) .

In a third variant, S700 can include generating an updated set of model inputs from the updated scene construct and passing the updated set of model inputs to the generative model, wherein the generative model renders the frame(s) de novo (e.g., using the updated scene context, updated 3D scene reference, etc.).

In a fourth variant, S700 can include passing the changes to the model inputs to the generative model, wherein the generative model only rerenders portions of the frame(s) associated with the changes (e.g., pixels associated with edited object instances)

However, automatically updating the visual content based on the scene construct edit S700 may be otherwise performed.

The method can optionally include generating timeseries visual assets based on the visual content S800, which functions to generate video, gameplay, and/or other timeseries media. S800 can be performed using a graphics engine (e.g., game engine, rendering engine, etc.), generative model (e.g., diffusion model, GAN, etc.; capable of generating video), and/or any other module. The visual content (e.g., frames) generated in S400 can be treated as keyframes for video rendering, or otherwise used. The timeseries visual assets can be generated in real-or near-real time, asynchronously with static visual content generation, and/or at any other time. In an example, keyframes can be generated at a predetermined frequency during gameplay (e.g., using S100-S400), wherein a realtime graphics engine can generate intermediate frames between keyframe generation. Auxiliary inputs for the rendering module (e.g., textures, materials, lighting, scene geometry, animations, physics data, etc.) can be: automatically extracted from the 3D scene, from the scene context, predicted by an LLM, specified by a user, and/or otherwise determined. Additionally or alternatively, the visual content (e.g., frames), scene context, geometric representation, and/or auxiliary information (e.g., scripts, audio recordings, audio conditioning inputs, etc.) can be provided to secondary generative models (e.g., VEO3, dialogue models, animation models, etc.) to generate augmented content (e.g., the visual content augmented with additional modalities). However, generating timeseries visual assets based on the visual content S800 may be otherwise performed.

However, the method can be otherwise performed.

### 5. Specific Examples

Specific example 1. A method for dynamic visual asset generation, comprising: receiving a scene generation prompt; determining a set of object instances based on the scene generation prompt, wherein each object instance is associated with an object instance description predicted from the scene generation prompt; generating a scene construct by populating a 3D scene with a set of 3D models for the set of object instances, wherein each 3D model is associated with the object instance description for the respective object instance; generating a set of model inputs from the scene construct, comprising generating a 2D reference image from the 3D scene and generating a scene context based on the object instance descriptions associated with the set of 3D models; and generating an appearance-rendered image based on the set of model inputs using a generative model.

Specific example 2. The method of specific example 1, wherein the 2D reference image depicts geometries for the set of object instances and does not depict appearances for the set of object instances.

Specific example 3. The method of specific example 1, wherein each object instance is associated with an object type, wherein each object type identifies the respective 3D model for 3D scene population.

Specific example 4. The method of specific example 3, wherein the object type further defines a set of parameter values, wherein the description for the object instance is augmented based on the respective set of parameter values.

Specific example 5. The method of specific example 3, wherein poses for each of the set of 3D models within the 3D scene are determined from a relationship database embedding spatial relationships between the respective object types.

Specific example 6. The method of specific example 1, wherein determining the set of object instances based on the scene generation prompt comprises: extracting a set of object types from the scene generation prompt; identifying a set of child object types of the extracted set of object types within a knowledge graph; and generating object instances based on the extracted set of object types and the set of child object types.

Specific example 7. The method of specific example 1, wherein the set of object instances is determined from the scene generation prompt using a large language model.

Specific example 8. The method of specific example 1, wherein the 2D reference image is generated from a view frustum of a virtual camera placed within the 3D scene.

Specific example 9. The method of specific example 1, wherein the scene context is generated from object instance descriptions associated with the 3D models of object instances depicted within the 2D reference image.

Specific example 10.The method of specific example 1, wherein the scene context further comprises a scene description defining a target visual appearance of the appearance-rendered frame (e.g., image).

Specific example 11.The method of specific example 1, wherein the object instance description and the scene context are in natural language text.

Specific example 12.The method of specific example 1, further comprising generating a timeseries of intermediary frames using the appearance-rendered frame (e.g., image) as a keyframe.

Specific example 13.The method of specific example 1, further comprising: receiving an edit to the scene construct; generating an updated set of model inputs based on the edit; and generating an updated appearance-rendered frame (e.g., image) based on the updated set of model inputs.

Specific example 14.The method of specific example 13, wherein the edit comprises an edit to an object instance description of an object instance within the set of object instances.

Specific example 15.A system for dynamic visual asset generation, comprising: a knowledge graph comprising a hierarchical set of object types, wherein each object type comprises a set of values for each of a set of parameters; an asset database comprising a set of 3D models referenced by the set of object types; an interpretation agent configured to determine a set of object instances from a scene generation prompt, wherein each object instance is associated with an object type within the knowledge graph and a description; a populator agent configured to populate a 3D scene using 3D models referenced by the object types for the set of object instances; and a scene summary agent configured to determine a geometric scene reference from the 3D scene and a scene context from the descriptions for the set of object instances, wherein an appearance-rendered frame (e.g., image) is generated from the geometric scene reference and the scene context using a generative model.

Specific example 16.The system of specific example 15, wherein the determined set of object instances comprises object instances for object types that are not explicitly mentioned in the scene generation prompt.

Specific example 17.The system of specific example 16, wherein the determined set of object instances comprises child object types of object types that are explicitly mentioned in the scene generation prompt, wherein the child object types are identified from the knowledge graph.

Specific example 18.The system of specific example 15, wherein the values for each of the set of parameters, the descriptions, and the scene context are expressed in natural language.

Specific example 19.The system of specific example 15, further comprising a relationship database embedding spatial relationships between object types.

Specific example 20. The system of specific example 15, wherein the knowledge graph is automatically augmented to include new object types, comprising:
determining that an object instance extracted from the scene generation prompt differs from existing object types in the knowledge graph; identifying a closest existing object type within the knowledge graph; generating a new object type for the object instance based on parameter values for the existing object type; and updating the parameter values for the new object type using updated parameter values predicted for the object instance.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken lines in the figures. However, unbroken lines in the figures should not be interpreted to indicate that the depicted elements are essential, nor to indicate that the depicted elements may not be omitted from variants of the invention.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for dynamic visual asset generation, comprising:
receiving a scene generation prompt;
determining a set of object instances based on the scene generation prompt, wherein each object instance is associated with an object instance description predicted from the scene generation prompt;
generating a scene construct by populating a 3D scene with a set of 3D models for the set of object instances, wherein each 3D model is associated with the object instance description for the respective object instance;
generating a set of model inputs from the scene construct, comprising generating a 2D reference image from the 3D scene and generating a scene context based on the object instance descriptions associated with the set of 3D models; and
generating an appearance rendered frame based on the set of model inputs using a generative model.

2. The method of claim 1, wherein the 2D reference image depicts geometries for the set of object instances and does not depict appearances for the set of object instances.

3. The method of claim 1, wherein each object instance is associated with an object type, wherein each object type identifies the respective 3D model for 3D scene population.

4. The method of claim 3, wherein the object type further defines a set of parameter values, wherein the description for the object instance is augmented based on the respective set of parameter values.

5. The method of claim 3, wherein poses for each of the set of 3D models within the 3D scene are determined from a relationship database embedding spatial relationships between the respective object types.

6. The method of claim 1, wherein determining the set of object instances based on the scene generation prompt comprises:
extracting a set of object types from the scene generation prompt;
identifying a set of child object types of the extracted set of object types within a knowledge graph; and
generating object instances based on the extracted set of object types and the set of child object types.

7. The method of claim 1, wherein the set of object instances is determined from the scene generation prompt using a large language model.

8. The method of claim 1, wherein the 2D reference image is generated from a view frustum of a virtual camera placed within the 3D scene.

9. The method of claim 1, wherein the scene context is generated from object instance descriptions associated with the 3D models of object instances depicted within the 2D reference image.

10. The method of claim 1, wherein the scene context further comprises a scene description defining a target visual appearance of the appearance rendered frame.

11. The method of claim 1, wherein the object instance description and the scene context are in natural language text.

12. The method of claim 1, further comprising generating a timeseries of intermediary frames using the appearance rendered frame as a keyframe.

13. The method of claim 1, further comprising:
receiving an edit to the scene construct;
generating an updated set of model inputs based on the edit; and
generating an updated appearance rendered frame based on the updated set of model inputs.

14. The method of claim 13, wherein the edit comprises an edit to an object instance description of an object instance within the set of object instances.

15. A system for dynamic visual asset generation, comprising:
a knowledge graph comprising a hierarchical set of object types, wherein each object type comprises a set of values for each of a set of parameters;
an asset database comprising a set of 3D models referenced by the set of object types;
an interpretation agent configured to determine a set of object instances from a scene generation prompt, wherein each object instance is associated with an object type within the knowledge graph and a description;
a populator agent configured to populate a 3D scene using 3D models referenced by the object types for the set of object instances; and
a scene summary agent configured to determine a geometric scene reference from the 3D scene and a scene context from the descriptions for the set of object instances, wherein an appearance-rendered image is generated from the geometric scene reference and the scene context using a generative model.

16. The system of claim 15, wherein the determined set of object instances comprises object instances for object types that are not explicitly mentioned in the scene generation prompt.

17. The system of claim 16, wherein the determined set of object instances comprises child object types of object types that are explicitly mentioned in the scene generation prompt, wherein the child object types are identified from the knowledge graph.

18. The system of claim 15, wherein the values for each of the set of parameters, the descriptions, and the scene context are expressed in natural language.

19. The system of claim 15, further comprising a relationship database embedding spatial relationships between object types.

20. The system of claim 15, wherein the knowledge graph is automatically augmented to include new object types, comprising:
determining that an object instance extracted from the scene generation prompt differs from existing object types in the knowledge graph;
identifying a closest existing object type within the knowledge graph;
generating a new object type for the object instance based on parameter values for the existing object type; and
updating the parameter values for the new object type using updated parameter values predicted for the object instance.
